(19) United States
(12) Patent Application Publication
(10) Pub. No.: US 2026/0194800 A1
(43) Pub. Date: Jul. 9, 2026

(54) ILLUMINATION DEVICE AND OPTICAL APPARATUS

(71) Applicant: SEIKO EPSON CORPORATION, Tokyo (JP)

(72) Inventors: Koya SHIRATORI, MATSUMOTO-SHI (JP); Eiji MORIKUNI, MATSUMOTO-SHI (JP)

(21) Appl. No.: 19/441,455

(22) Filed: Jan. 6, 2026

(30) Foreign Application Priority Data
Jan. 7, 2025 (JP) 2025-002340

(51) Int. Cl. G03B 21/20

(52) U.S. Cl. CPC G03B 21/208; G03B 21/2013

(57) ABSTRACT

An illumination device according to an embodiment includes a first light source configured to emit first light, a collimating element, a second light source configured to emit second light toward an optical path of the first light, an optical element disposed the optical path of the first light and the second light emitted from the second light source, and a lens array disposed between the collimating element and the optical element and including a plurality of small lenses. In the lens array, m small lenses are arranged along a first axis, and n small lenses are arranged along a second axis crossing the first axis. The numbers satisfy m≥2 and n≥m. The optical element is zoned into a first region where the first light is transmitted and the second light is blocked and a second region where the first light and the second light are transmitted. In the illumination device, a smaller number of shadows than n overlap each other at imaging surface by the first light that is emitted from the plurality of small lenses of the lens array, then is incident on the optical element, and then passes through a peripheral edge of the first region being projected onto the imaging surface.

The present application is based on, and claims priority from JP Application Serial Number 2025-002340, filed Jan. 7, 2025, the disclosure of which is hereby incorporated by reference herein in its entirety.

### BACKGROUND

### 1. Technical Field

The present disclosure relates to an illumination device and an optical apparatus.

### 2. Related Art

In an optical apparatus such as a projector or an exposure apparatus, an illumination optical system including a lens array may be used in some cases in order to reduce illuminance unevenness in illumination light.

For example, JP-A-2007-264009 discloses a projector including a light source, an illumination optical system that forms illumination light obtained by homogenizing light emitted from the light source, a light modulation device on which the illumination light emitted from the illumination optical system is incident, a projection optical system that projects image light formed by the light modulation device, and a light blocking member disposed in the vicinity of a conjugate position of the light modulation device at the illumination optical system side on an optical path. The illumination optical system disclosed in JP-A-2007-264009 includes an integrator optical system for splitting the light emitted from the light source and then superimposing the light thus split. The integrator optical system includes a pair of lens arrays. The lens arrays each include a plurality of small lenses arranged in a matrix on a plane crossing an optical axis of the incident light.

The light blocking member disclosed in JP-A-2007-264009 is disposed on the optical path and between, for example, the light source and closer one of the pair of lens arrays to the light source. The light blocking member has a light blocking portion (blocking portion) formed of, for example, a cross-shaped pattern (predetermined pattern) when viewed along an incident direction of the light. In the projector disclosed in JP-A-2007-264009, in order to make the illumination light incident on a modulation surface of the light modulation device without leakage, the illumination light illuminates a region that includes the modulation surface and is slightly larger than the modulation surface. The light with which a region outside the modulation surface is illuminated is not converted into the image light, and may deteriorate a retardation element and a polarization element disposed on the optical path between the light modulation device and the projection optical system. The crisscross pattern of the light blocking member is disposed at an incident position of the light that is not converted into the image light by the light modulation device as described above out of the light incident from the light source, and blocks the light that is not converted into the image light by the light modulation device. In the projector disclosed in JP-A-2007-264009, by providing the light blocking member, it is possible to prevent the deterioration of an optical element such as the retardation element disposed on the optical path between the light modulation device and the projection optical system.

JP-A-2007-264009 is an example of the related art.

In the optical apparatus such as a projector, in order to control a visible image that is a display target and is formed of visible light, the visible image and an invisible image made of, for example, infrared light are superimposed on the display surface, and a relative arrangement of components in the apparatus or conditions and operations in the apparatus that forms the image light may be adjusted in some cases based on information that can be acquired from the invisible image. In this case, the optical element provided with a predetermined pattern is disposed at a position close to the light modulation device that forms the image light on the optical path of the visible light and the infrared light.

The predetermined pattern of the light blocking member disclosed in JP-A-2007-264009 does not have spectral characteristics of transmitting the visible light and blocking the invisible light having a wavelength band different from a visible wavelength band. Specifically, the predetermined pattern of the light blocking member blocks the visible light that has a predetermined wavelength band and is emitted from the light source, but does not transmit the invisible light. Both the visible light and the invisible light are transmitted through an opening provided to the light blocking member. Even when the spectral characteristics are provided to the light blocking member disclosed in JP-A-2007-264009, and the light blocking member is disposed as the optical element for forming patterned light in the optical apparatus, there is a possibility that the visible light is scattered or diffracted at an edge of a layer or a film constituting the pattern to cause illuminance unevenness or color difference of image light due to the scattered light or the diffracted light. That is, in the illumination device including the optical element for generating the patterned light in a second wavelength band such as the infrared wavelength band, when light in a first wavelength band as the visible wavelength band in which the patterned light is not originally generated is incident, there is required a countermeasure for suppressing the illuminance unevenness in the light in the first wavelength band caused by the scattered light, the diffracted light, or the like according to the predetermined pattern and for reducing the visibility of the pattern with the light in the first wavelength band.

### SUMMARY

An illumination device of an aspect of the present disclosure includes a first light source configured to emit first light having a first wavelength band, a collimating element configured to collimate the first light emitted from the first light source, a second light source configured to emit second light having a second wavelength band different from the first wavelength band toward an optical path of the first light emitted from the collimating element, an optical element disposed on the optical path of the first light emitted from the collimating element and the second light emitted from the second light source, and a lens array disposed on the optical path of the first light between the collimating element and the optical element. The lens array includes a plurality of small lenses. An imaging surface of the first light incident on the small lenses is located at an exit side of the first light with respect to the optical element. In the lens array, m small lenses each identical to the small lens are arranged along a first axis contained in a plane crossing an optical axis of the first light incident on the lens array, and n small lenses each identical to the small lens are arranged along a second axis that is contained in the plane and crosses the first axis. The number m is a natural number no smaller than 2, and the number n is a natural number no smaller than m. The optical element is zoned, when viewed along the optical path of the first light incident on the optical element, into a first region where the first light is transmitted and the second light is blocked, and a second region where the first light and the second light are transmitted. In the illumination device of this aspect of the present disclosure, a distance in the optical path of the first light between the lens array and the imaging surface, a distance in the optical path of the first light between the optical element and the imaging surface, the natural numbers m, n, and a ratio between a diameter on the first axis and a diameter on the second axis of the small lens are set so that smaller than n shadows of the first light by the first light overlap each other on the imaging surface by the first light which is emitted from the plurality of small lenses of the lens array, is then incident on the optical element, and then passes through a peripheral edge of the first region being projected onto the imaging surface.

### BRIEF DESCRIPTION OF THE DRAWINGS

FIG. 1 is a schematic diagram of a projector according to a first embodiment.

FIG. 2 is a front view of an optical element of the projector shown in FIG. 1.

FIG. 3 is a schematic diagram of an illumination device of the projector according to the first embodiment.

FIG. 4 is a cross-sectional view of the optical element in FIG. 2, and is a diagram viewed along the arrowed line IV-IV shown in FIG. 2.

FIG. 5 is a schematic diagram of a part of green light emitted from an optical element of an illumination device of the related art.

FIG. 6 is a schematic diagram of a part of infrared light emitted from the optical element in FIG. 2.

FIG. 7 is a schematic diagram of the illumination device in FIG. 3.

FIG. 8 is a schematic diagram of the illumination device in FIG. 3.

FIG. 9 is a schematic diagram of the illumination device in FIG. 3.

FIG. 10 is a schematic diagram of a shadow of green light generated on an imaging surface of the illumination device in FIG. 3.

FIG. 11 is a schematic diagram related to a relative position of the shadow of the green light in FIG. 10.

FIG. 12 is a schematic diagram related to the relative position of the shadow by the green light in FIG. 10.

FIG. 13 is another schematic diagram of the shadow by the green light generated on a modulation surface of the light modulation device of the illumination device in FIG. 3.

FIG. 14 is a schematic diagram related to the relative position of the shadow by the green light in FIG. 13.

FIG. 15 is a schematic diagram related to the relative position of the shadow by the green light in FIG. 13.

FIG. 16 is a schematic diagram related to the relative position of the shadow by the green light in FIG. 13.

FIG. 17 is a schematic diagram of a shadow of green light generated on a modulation surface of a light modulation device of an illumination device of the related art.

FIG. 18 is a front view of an optical element of an illumination device of a second embodiment.

FIG. 19 is a schematic diagram of a shadow of green light generated on an imaging surface of an illumination device of the second embodiment.

FIG. 20 is a schematic diagram of the shadow by the green light generated on the imaging surface of the illumination device of the second embodiment.

FIG. 21 is a schematic diagram related to a relative position of the shadow by the green light in FIG. 20.

FIG. 22 is a schematic diagram related to the relative position of the shadow by the green light in FIG. 20.

FIG. 23 is a schematic diagram of an illumination region of the green light on the imaging surface of the illumination device in FIG. 3.

FIG. 24 is a schematic diagram of an illumination region of green light on an imaging surface of an illumination device according to a third embodiment.

FIG. 25 is a schematic diagram of the illumination region of the green light on the imaging surface of the illumination device according to the third embodiment.

FIG. 26 is a schematic diagram of a first region and a blocking portion of a modified example of the optical element in FIG. 3 or the optical element in FIG. 18.

### DESCRIPTION OF EMBODIMENTS

Embodiments of the present disclosure will hereinafter be described with reference to the drawings. In the drawings, dimensional scales may be changed in some cases depending on the elements in order to make the elements eye-friendly.

### First Embodiment

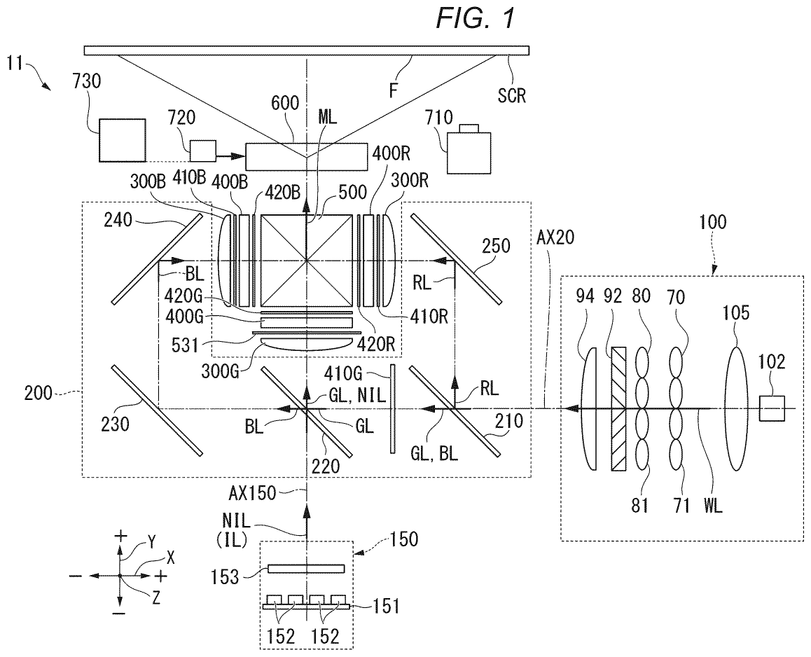

First, a first embodiment of the present disclosure will be described with reference to FIGS. 1 to 17. FIG. 1 is a schematic diagram showing a configuration of a projector 11 according to the first embodiment of the present disclosure. The projector 11 is an optical apparatus and an image display apparatus including three liquid crystal panels as a light modulation device, and is a so-called three-plate projector. The projector 11 corresponds to an optical apparatus described later and an optical apparatus set forth in the appended claims. Projector

As shown in FIG. 1, the projector 11 is provided with a light source device 100, a light source device 150, a color separation optical system 200, field lenses 300R, 300G, and 300B, incident-side polarization plates 410R, 410G, and 410B, light modulation devices 400R, 400G, and 400B, exit-side polarization plates 420R, 420G, and 420B, an optical element 531, a cross dichroic prism 500 which is a light combining element, a projection optical system 600, an imaging device 710, a movement mechanism 720, and a control device 730.

The light source device 100 includes a light emitting element 102, a collimating element 105, a first lens array 70, a second lens array 80, a polarization conversion element 92, and a superimposing lens 94. The light source device 100 emits white light WL.

The light source device 100 emits the white light WL toward a −X side along an X axis. In the following description, an axis parallel to an optical axis of the white light WL emitted from the light source device 100 is defined as the X axis, one side in the X axis is defined as the −X side, and the other side in the X axis is defined as a +X side. An axis orthogonal to the X axis is defined as a Y axis, one side in the Y axis is defined as a −Y side, and the other side in the Y axis is defined as a +Y side. An axis orthogonal to a plane including the X axis and the Y axis is defined as a Z axis, one side in the Z axis is defined as a −Z side, and the other side in the Z axis is defined as a +Z side. Note that viewing along the Z axis means a plan view.

The light emitting element 102 may be configured with, for example, a white light emitting diode (LED) obtained by mounting a red LED, a green LED, and a blue LED on a common chip, or may include an LED or a laser diode (LD) that emits blue light and a phosphor that is excited by a part of the blue light emitted from the LED or the LD to emit yellow light as fluorescence. The light emitting element 102 emits, toward the −X side, the white light WL which spreads in a plane including the Y axis and the Z axis as proceeding from the +X side toward the −X side around the X axis.

The collimating element 105 is disposed at the −X side of the light emitting element 102 and is disposed in a region substantially overlapping an irradiation region with the white light WL emitted from the light emitting element 102 on a plane including the Y axis and the Z axis.

Note that a detailed configuration of the light source device 100 is not limited to a specific configuration as long as the light source device 100 can emit the white light WL.

The white light WL emitted from the collimating element 105 is collimated along the X axis and then enters the first lens array 70 from the +X side. The first lens array 70 is disposed at the −X side of the collimating element 105. The first lens array 70 has a plurality of small lenses 71 for dividing the white light WL collimated along the X axis by the collimating element 105 into a plurality of partial light fluxes in a plane including the Y axis and the Z axis. The plurality of small lenses 71 is arranged in a matrix in a plane that is perpendicular to the optical axis AX20 of the white light WL and includes the Y axis and the Z axis in the light source device 100. The small lens 71 is, for example, a biconvex lens having a plane of incidence convex toward the +X side and an exit surface convex toward the −X side.

The second lens array 80 is disposed at the −X side of the first lens array 70, and is disposed in a region substantially overlapping the first lens array 70 in a plane including the Y axis and the Z axis. The second lens array 80 includes a plurality of small lenses 81 corresponding to the plurality of small lenses 71 of the first lens array 70. The plurality of small lenses 81 is arranged in a matrix in a plane including the Y axis and the Z axis. The second lens array 80 forms images that are provided by the small lenses 71 of the first lens array 70 in the vicinity of an image formation region of each of the light modulation devices 400R, 400G, and 400B in cooperation with the superimposing lens 94. The small lens 81 is, for example, a biconvex lens having a plane of incidence convex toward the +X side and an exit surface convex toward the −X side.

The polarization conversion element 92 is disposed at the −X side of the second lens array 80, and is disposed in a region substantially overlapping the second lens array 80 in a plane including the Y axis and the Z axis. The polarization conversion element 92 is disposed at the −X side of the second lens array 80. The polarization conversion element 92 includes a polarization separation layer, a reflecting layer, and a wave plate all not shown. The polarization conversion element 92 converts the partial light fluxes emitted from the second lens array 80 toward the +X side along the X axis into linearly polarized light. The polarization conversion element 92 is formed in a plate shape as a whole. Plate surfaces of the polarization conversion element 92 are disposed in parallel to a plane including the Y axis and the Z axis, that is, a plane perpendicular to the optical axis AX20.

The polarization separation layer of the polarization conversion element 92 transmits one linear polarization component out of polarization components contained in the partial light fluxes emitted from the second lens array 80, and reflects the other linear polarization component toward a direction perpendicular to the optical axis AX20. The reflecting layer of the polarization conversion element 92 reflects the other linear polarization component, which is reflected by the polarization separation layer, toward a direction parallel to the optical axis AX20 along the X axis. The wave plate of the polarization conversion element 92 converts the other linear polarization component reflected by the reflecting layer into the one linear polarization component.

The superimposing lens 94 is disposed at the −X side of the polarization conversion element 92, and is disposed in a region substantially overlapping the second lens array 80 in a plane including the Y axis and the Z axis. The center of the superimposing lens 94 is disposed on the optical axis AX20. The superimposing lens 94 is, for example, a plano-convex lens having a plane of incidence that is flat and is parallel to a plane including the X axis and the Y axis and an exit surface convex toward the −X side.

The superimposing lens 94 collects the partial light fluxes emitted from the polarization conversion element 92 toward the +X side along the X axis and then superimposes the partial light fluxes thus collected on one another in the vicinity of the image formation region of each of the light modulation devices 400R, 400G, and 400B. The first lens array 70, the second lens array 80, and the superimposing lens 94 constitute an integrator optical system. The integrator optical system homogenizes a light intensity distribution of the white light WL emitted from the light source device 100 in a plane including the Y axis and the Z axis in the image formation region of each of the light modulation devices 400R, 400G, and 400B.

The color separation optical system 200 includes dichroic mirrors 210, 220 and reflecting mirrors 230, 240, and 250. The color separation optical system 200 separates the white light WL emitted from the light source device 100 toward the +X side along the X axis into red light RL, green light GL, and blue light BL, which are visible light, and guides the red light RL, the green light GL, and the blue light BL to the light modulation devices 400R, 400G, and 400B, respectively. Infrared light IL is incident from the light source device 150 on the dichroic mirror 220.

The dichroic mirror 210 is disposed at the −X side of the superimposing lens 94 of the light source device 100. In the white light WL incident from the +X side along the X axis, the dichroic mirror 210 transmits the green light GL and the blue light BL toward the −X side, and reflects the red light RL toward the +Y side along the Y axis.

The dichroic mirror 220 is disposed at the −X side of the dichroic mirror 210 and is disposed in a region substantially overlapping the dichroic mirror 210 in a plane including the Y axis and the Z axis. The dichroic mirror 220 transmits, toward the −X side, the blue light BL out of the green light GL and the blue light BL incident from the +X side along the X axis, and reflects the green light GL toward the +Y side along the Y axis. The dichroic mirror 220 transmits the infrared light IL incident from the −Y side along the Y axis.

The incident-side polarization plate 410G is disposed on an optical path of the green light GL and the blue light BL between the dichroic mirrors 210, 220, and off an optical path of the infrared light IL. The incident-side polarization plate 410G is disposed in a region substantially overlapping the dichroic mirrors 210, 220 in a plane including the Y axis and the Z axis. The incident-side polarization plate 410G transmits, toward the −X side along the X axis, S-polarized light of the green light GL incident from the +X side along the X axis, and reflects or absorbs the P-polarized light of the green light GL. The incident-side polarization plate 410G transmits the blue light BL incident from the +X side along the X axis. The incident-side polarization plate 410G is, for example, an inorganic polarization plate.

The reflecting mirror 230 is disposed at the −X side of the dichroic mirror 220 and is disposed in a region substantially overlapping the dichroic mirror 220 in a plane including the Y axis and the Z axis. The reflecting mirror 230 reflects, toward the +Y side along the Y axis, the blue light BL incident from the +X side along the X axis. The reflecting mirror 240 is disposed at the +Y side of the reflecting mirror 230 and is disposed in a region substantially overlapping the reflecting mirror 230 in a plane including the X axis and the Z axis. The reflecting mirror 240 reflects, toward the +X side along the X axis, the blue light BL incident from the −Y side along the Y axis.

The reflecting mirror 250 is disposed at the +Y side of the dichroic mirror 210, and is disposed in a region substantially overlapping the dichroic mirror 210 in a plane including the X axis and the Z axis, and in a region substantially overlapping the reflecting mirror 240 in a plane including the Y axis and the Z axis. The reflecting mirror 250 reflects, toward the −X side along the X axis, the red light RL incident from the −Y side along the Y axis.

The cross dichroic prism 500 is disposed in a region where an optical path of the red light RL reflected by the reflecting mirror 250 and emitted toward the −X side along the X axis, an optical path of the green light GL reflected by the dichroic mirror 220 and emitted toward the +Y side along the Y axis, and an optical path of the blue light BL reflected by the reflecting mirror 240 and emitted toward the +X side along the X axis overlap each other.

The length of the optical path of the blue light BL from the dichroic mirror 210 to the cross dichroic prism 500 is longer than the lengths of the optical paths of the red light RL and the green light GL from the dichroic mirror 210 to the cross dichroic prism 500. Relay lenses not shown may be disposed on the optical path of the blue light BL between the dichroic mirror 220 and the reflecting mirror 230, and the optical path of the blue light BL between the reflecting mirrors 230, 240, respectively. By disposing the relay lens, a loss of the blue light BL longer in optical path length compared to the red light RL and the green light GL is reduced as described above.

The field lens 300R, the incident-side polarization plate 410R, the light modulation device 400R, and the exit-side polarization plate 420R are sequentially arranged from the +X side toward the −X side along the X axis on the optical path of the red light RL between the reflecting mirror 250 and the cross dichroic prism 500. The red light RL reflected by the reflecting mirror 250 passes through the field lens 300R and enters the incident-side polarization plate 410R. The incident-side polarization plate 410R is disposed on the optical path of the red light RL between the field lens 300R and the light modulation device 400R. The incident-side polarization plate 410R transmits, toward the −X side, S-polarized light of the red light RL incident from the +X side along the X axis, and reflects or absorbs P-polarized light of the red light RL.

The S-polarized light of the red light RL emitted from the incident-side polarization plate 410R is incident on the image formation region of the light modulation device 400R and is converted by the light modulation device 400R into red image light. The light modulation device 400R modulates the red light RL incident from the +X side along the X axis in accordance with image information input from an image input apparatus, a control device, or the like not shown to form the red image light, and then emits the red image light toward the −X side along the X axis. The light modulation devices 400R, 400G, and 400B are each configured, for example, with a liquid crystal panel. An operation mode of the liquid crystal panel may be any one of a TN mode, a VA mode, a lateral electric field mode, and the like, and is not limited to a specific mode.

The red image light emitted from the light modulation device 400R enters the exit-side polarization plate 420R.

The exit-side polarization plate 420R is disposed on an optical path of the red image light between the light modulation device 400R and the cross dichroic prism 500. The exit-side polarization plate 420R transmits, toward the −X side, P-polarized light of the red image light incident from the +X side along the X axis, and reflects or absorbs S-polarized light of the red image light.

The field lens 300G, the optical element 531, the light modulation device 400G, and the exit-side polarization plate 420G are sequentially arranged from the −Y side toward the +Y side along the Y axis on the optical path of the green light GL between the dichroic mirror 220 and the cross dichroic prism 500. The green light GL reflected by the dichroic mirror 220 passes through the field lens 300G and the optical element 531, and then enters the light modulation device 400G. A configuration of the optical element 531, a behavior of the green light GL passing through the integrator optical system and the optical element 531, and a behavior of the infrared light IL passing through the optical element 531 will be described later.

The S-polarized light of the green light GL emitted from the field lens 300G is incident on the image formation region of the light modulation device 400G and is converted by the light modulation device 400G into green image light. The light modulation device 400G modulates the green light GL incident from the −Y side in accordance with the image information input from the image input apparatus, the control device, or the like all not shown to form the green image light, and then emits the green image light toward the +Y side along the Y axis.

The green image light emitted from the light modulation device 400G enters the exit-side polarization plate 420G.

The exit-side polarization plate 420G is disposed on an optical path of the green image light between the light modulation device 400G and the cross dichroic prism 500. The exit-side polarization plate 420G transmits, toward the +Y side along the Y axis, P-polarized light of the green image light incident thereon, and reflects or absorbs S-polarized light of the green image light. The exit-side polarization plate 420G is, for example, an organic polarization plate.

The field lens 300B, the incident-side polarization plate 410B, the light modulation device 400B, and the exit-side polarization plate 420B are sequentially arranged from the −X side toward the +X side along the X axis on the optical path of the blue light BL between the reflecting mirror 240 and the cross dichroic prism 500. The blue light BL reflected by the reflecting mirror 240 passes through the field lens 300B and enters the incident-side polarization plate 410B. The incident-side polarization plate 410B is disposed on the optical path of the blue light BL between the field lens 300B and the light modulation device 400B. The incident-side polarization plate 410B transmits, toward the +X side, S-polarized light of the blue light BL incident from the −X side along the X axis, and reflects or absorbs P-polarized light of the blue light BL.

The S-polarized light of the blue light BL emitted from the incident-side polarization plate 410B is incident on the image formation region of the light modulation device 400B and is converted by the light modulation device 400B into blue image light. The light modulation device 400B modulates the blue light BL incident from the −X side along the X axis in accordance with the image information input from the image input apparatus, the control device, or the like all not shown to form the blue image light, and then emits the blue image light toward the +X side along the X axis.

The blue image light emitted from the light modulation device 400B enters the exit-side polarization plate 420B.

The exit-side polarization plate 420B is disposed on an optical path of the blue image light between the light modulation device 400B and the cross dichroic prism 500. The exit-side polarization plate 420B transmits, toward the +X side, P-polarized light of the blue image light incident from the −X side along the X axis, and reflects or absorbs S-polarized light of the blue image light.

The light source device 150 includes a substrate 151, a plurality of light emitting elements 152, and a homogenization element 153. The substrate 151 and the homogenization element 153 are disposed in a region substantially overlapping the dichroic mirror 220 of the color separation optical system 200 in a plane including the X axis and the Z axis. The substrate 151 is, for example, a plate-shaped member made of metal. The substrate 151 has plate surfaces parallel to a plane including the X axis and the Z axis. In the substrate 151, the plurality of light emitting elements 152 are disposed at the plate surface located at the +Y side and facing the dichroic mirror 220.

The light emitting elements 152 emit the infrared light IL toward the +Y side along the Y axis. The wavelength of the infrared light IL is, for example, equal to or longer than 930 nm and equal to or shorter than 950 nm, and belongs to a near-infrared wavelength band. Note that the light source device 150 may include only a single light emitting element 152. The light emitting elements 152 may each be, for example, an LED that emits the infrared light IL.

The homogenization element 153 is disposed at the +Y side of the plurality of light emitting elements 152, and is disposed on the optical path of the infrared light IL emitted from the plurality of light emitting elements 152 between the plurality of light emitting elements 152 and the dichroic mirror 220 of the color separation optical system 200. The homogenization element 153 homogenizes a light intensity distribution of a luminous flux of the infrared light IL emitted from the plurality of light emitting elements 152 in a plane perpendicular to an optical axis AX150 of the luminous flux of the infrared light IL, that is, a plane including the X axis and the Z axis. The homogenization element 153 emits the infrared light IL having the homogenous light intensity distribution in the plane including the X axis and the Z axis toward the +Y side along the Y axis, that is, toward the dichroic mirror 220.

The homogenization element 153 is, for example, a light collecting lens including at least one convex lens, a holographic optical element (HOE) formed of a computer-generated hologram (CGH), or a diffractive optical element (DOE),

The infrared light IL emitted from the homogenization element 153 of the light source device 150 toward the +Y side along the Y axis is transmitted through the dichroic mirror 220 of the color separation optical system 200 to further be emitted toward the +Y side, and sequentially passes through the field lens 300G and the optical element 531.

The infrared light IL passing through the optical element 531 forms patterned light having a predetermined pattern in a plane including the X axis and the Z axis. The patterned light formed with the infrared light IL is incident on the image formation region of the light modulation device 400G, but is not converted into the image light by the light modulation device 400G and is emitted from the light modulation device 400G toward the +Y side along the Y axis. The exit-side polarization plate 420G transmits, toward the +Y side along the Y axis, P-polarized light of the infrared light IL incident thereon, and reflects or absorbs S-polarized light of the infrared light IL.

The cross dichroic prism 500 reflects the red image light emitted from the exit-side polarization plate 420R and incident from the +X side along the X axis, and emits the red image light toward the +Y side along the Y axis. The cross dichroic prism 500 transmits the green image light and the patterned light of the infrared light IL emitted from the exit-side polarization plate 420G and incident from the −Y side along the Y axis, and emits the green image light and the patterned light of the infrared light IL toward the +Y side along the Y axis to be superimposed on the red image light. The cross dichroic prism 500 reflects the blue image light emitted from the exit-side polarization plate 420B and incident from the −X side along the X axis, and emits the blue image light toward the +Y side along the Y axis to be superimposed on the red image light and the green image light.

The cross dichroic prism 500 includes four rectangular prisms integrally arranged so that apex angles thereof overlap each other at a common center position to form a substantially cubic shape as a whole. In the cross dichroic prism 500, dichroic mirrors configured with dielectric multilayer films or the like (not shown) are formed at interfaces on which the rectangular prisms are bonded to each other. The dielectric multilayer film (not shown) reflects one of the red light RL and the blue light BL incident along the X axis to emit the light thus reflected toward the +Y side along the Y axis, and transmits the green light GL incident from the −Y side along the Y axis to emit the green light GL toward the +Y side.

The cross dichroic prism 500 combines the image light emitted from the light modulation device 400R, the image light emitted from the light modulation device 400G, and the image light emitted from the light modulation device 400B with one another to generate image light ML as color image light, and emits the image light ML and the patterned light of the infrared light IL on an optical path common thereto in such a manner as described above.

The projection optical system 600 is disposed at the +Y side of the cross dichroic prism 500 and is disposed in a region substantially overlapping the cross dichroic prism 500 in a plane including the X axis and the Z axis. The projection optical system 600 projects the image light ML and the infrared light IL emitted from the cross dichroic prism 500 onto a screen SCR in an enlarged manner. The projection optical system 600 is configured with one or more optical lenses. Examples of the optical lenses may include a plano-convex lens, a biconvex lens, a biconcave lens, a meniscus lens, an aspherical lens, a free-form surface lens, and a cemented lens.

A projection surface of the screen SCR is disposed in parallel to a plane including the X axis and the Z axis, and is disposed so as to face the exit surface of the projection optical system 600.

The imaging device 710 is disposed at the −Y side of the screen SCR and is disposed at any place where the imaging device 710 does not block the light emitted from the projection optical system 600 in the projector 11. A light receiving surface of the imaging device 710 faces the projection surface of the screen SCR. The imaging device 710 captures an image of the pattern of the infrared light IL projected by the projection optical system 600. The imaging device 710 is, for example, an imaging camera sensitive to the infrared light IL. The imaging device 710 is, for example, a near-infrared camera device.

The infrared light IL is preferably near-infrared light NIL in a wavelength band equal to or longer than 930 nm and equal to or shorter than 950 nm. By using the near-infrared light NIL in the wavelength band equal to or longer than 930 nm and equal to or shorter than 950 nm, which is low in energy in the sunlight, as the infrared light IL, it is possible to prevent the contrast of the pattern of the infrared light IL from decreasing due to the influence of the sunlight when the screen SCR is irradiated with the infrared light IL. As a result, it is possible to achieve a good imaging accuracy of the pattern of the infrared light IL in the imaging device 710.

The movement mechanism 720 is disposed at an appropriate place around the projection optical system 600 in the projector 11, and is disposed at a place where the movement mechanism 720 does not block the light emitted from the projection optical system 600. The movement mechanism 720 receives an electric signal from the control device 730, and adjusts the position of the projection optical system 600 as appropriate to adjust positions of the projection image and the pattern of the infrared light IL on the screen SCR.

The control device 730 controls the movement mechanism 720 and the light modulation devices 400R, 400G, and 400B in accordance with the pattern of the infrared light IL captured by the imaging device 710. The control device 730 changes, in accordance with the pattern of the infrared light IL captured by the imaging device 710, at least one of, for example, a region and conditions for forming the red image light in an image display region of the light modulation device 400R, a region and conditions for forming the green image light in an image display region of the light modulation device 400G, and a region and conditions for forming the blue image light in an image display region of the light modulation device 400B.

The control device 730 is configured with, for example, a computer or an integrated circuit in which processing to be carried out by drivers that drive the imaging device 710, the movement mechanism 720, the light source device 150, and the light modulation devices 400R, 400G, and 400B is recorded as a program. The control device 730 is, for example, a processor. The control device 730 is electrically coupled to drive circuits for the imaging device 710, the movement mechanism 720, the light source device 150, and the light modulation devices 400R, 400G, and 400B with a wired or wireless configuration not shown.

### Optical Element

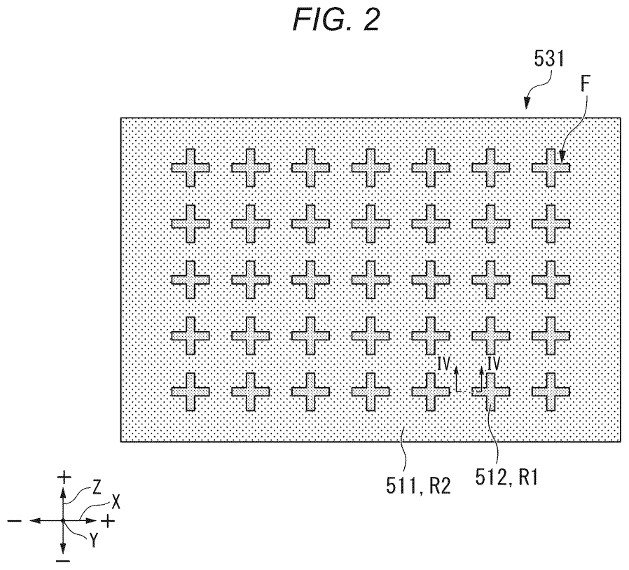

FIG. 2 is a front view of the optical element 531, and is a diagram viewed from the direction in which the green light GL and the infrared light IL are incident, that is, from the −Y side along the Y axis. As illustrated in FIG. 2, the optical element 531 includes a transmission portion 511 and blocking portions 512. The transmission portion 511 transmits both the green light GL and the infrared light IL to emit the green light GL and the infrared light IL toward the +Y side along the Y axis. The blocking portions 512 transmit the green light GL to emit the green light GL toward the +Y side along the Y axis, and reflect or absorb the infrared light IL to thereby block the infrared light IL.

The blocking portions 512 are arranged in a predetermined pattern F. The predetermined pattern F is, for example, a plurality of crisscross patterns. When viewed along the Y axis, each pattern that constitutes the blocking portion 512 has, for example, a crisscross shape. The blocking portions 512 are configured with, for example, crisscross regions two-dimensionally arranged at appropriate intervals along the X axis and the Z axis on a plate surface at the −Y side parallel to a surface including the X axis and the Z axis of a plate-shaped member constituting the optical element 531.

As described later, in an illumination device 601 according to the first embodiment, it is assumed that a shadow SD by the green light GL formed on a modulation surface of the light modulation device 400 by the small lenses 81 constituting the second lens array 80 is linearly formed. Therefore, the peripheral edges of the predetermined pattern F in the optical element 531 of the first embodiment including the crisscross patterns are formed of straight lines.

The predetermined pattern F is not limited to the plurality of crisscross patterns configured with the peripheral edges parallel to the X axis and the Z axis as illustrated in FIG. 2, and may be a pattern of one or more marks or characters configured with linear peripheral edges that can be imaged by the imaging device 710. The predetermined pattern F may be, for example, one or more crisscross patterns configured with peripheral edges parallel to an axis crossing the X axis and the Z axis, or may be one or more rectangular patterns configured with linear peripheral edges in a plane including the X axis and the Z axis.

In the first embodiment, the maximum dimension in a plane including the X axis and the Z axis of the blocking portions 512 each having a crisscross shape as a plurality of elements constituting the pattern F of the optical element 531 is equal to or larger than a distance ds between two shadows SD adjacent to each other on the modulation surface of the light modulation device 400G, that is, an imaging surface FB, that is, equal to or larger than a distance dsz or equal to or larger than a distance dsx as described later. Further, in the first embodiment, a minimum distance, which is an interval in a plane including the X axis and the Z axis between the plurality of blocking portions 512 each having the crisscross shape and constituting the pattern F, is equal to or less than the distance ds, that is, equal to or less than the distance dsz or equal to or less than the distance dsx.

### Illumination Device

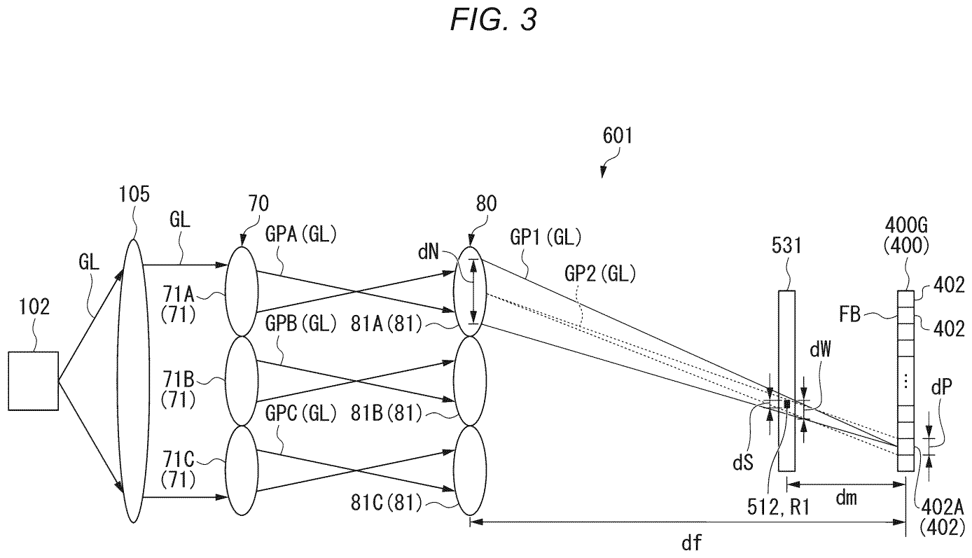

FIG. 3 is a schematic diagram of the illumination device 601 according to the first embodiment. The illumination device 601 is configured with the light emitting element 102 of the light source device 100, the collimating element 105, the light source device 150, the first lens array 70, the second lens array 80, the superimposing lens 94, the light emitting elements 152 of the light source device 150, the homogenization element 153, the optical element 531, and the light modulation device 400.

However, in FIG. 3, in order to enhance an understanding, out of the components constituting the illumination device 601, the light emitting element 102, the collimating element 105, the first lens array 70, the second lens array 80, the optical element 531, and the light modulation device 400 are illustrated, and the dichroic mirror 220, the light emitting elements 152, and the homogenization element 153 are omitted. In FIG. 3, three small lenses 71A, 71B, and 71C out of the plurality of small lenses 71 constituting the first lens array 70 are illustrated, and three small lenses 81A, 81B, and 81C out of the plurality of small lenses 81 constituting the second lens array 80 are illustrated.

In the illumination device 601, the light emitting element 102 corresponds to a first light source described later and a first light source set forth in the appended claims. The light emitting elements 152 correspond to a second light source described later and a second light source set forth in the appended claims. The second lens array 80 corresponds to a lens array described later and a lens array set forth in the appended claims.

In the illumination device 601, the green light GL contained in the white light WL emitted from the light emitting element 102 of the light source device 100 corresponds to first light described later and first light set forth in the appended claims. The green wavelength band including the wavelength of the green light GL corresponds to a first wavelength band described later and a first wavelength band set forth in the appended claims.

The light modulation device 400 corresponds to at least one of the light modulation devices 400R, 400G, and 400B. In the first embodiment, since the optical element 531 is disposed on the optical path of the green light GL between the field lens 300G and the light modulation device 400G as described above, the light modulation device 400G for green color corresponds to the light modulation device 400. The light modulation device 400 corresponds to an image processing device described later and an image processing device set forth in the appended claims. The modulation surface of the light modulation device 400G includes a plurality of pixels 402, corresponds to the imaging surface FB for the green light GL in the illumination device 601, and corresponds to a processing surface of the image processing device described later and a processing surface of an image processing device set forth in the appended claims.

In the illumination device 601 shown in FIG. 3, it is ignored that the optical path of the green light GL is bent along the Y axis before the green light GL enters the light modulation device 400G after being emitted from the superimposing lens 94 shown in FIG. 3. The optical path of the green light GL from the light emitting element 102 of the light source device 100 to the light modulation device 400G is linearly developed in the plan view and the side view.

As illustrated in FIG. 3, the green light GL contained in the white light WL emitted from the collimating element 105 is divided into green light beams GPA, GPB, and GPC, which are partial light fluxes, by the respective small lenses 71A, 71B, and 71C of the first lens array 70. After being emitted from the small lens 71A, the green light GPA forms, for example, an image, and enters the small lens 81A of the second lens array 80 in a diffused manner. After being emitted from the small lens 71B, the green light GPB forms, for example, an image, and enters the small lens 81B of the second lens array 80 in a diffused manner. After being emitted from the small lens 71C, the green light GPC forms, for example, an image, and enters the small lens 81C of the second lens array 80 in a diffused manner.

A distance between the second lens array 80 and the light modulation device 400G in the optical path of the green light GL is df. A distance between the optical element 531 and the light modulation device 400G in the optical path of the green light GL is dm.

FIG. 3 illustrates green light beams GP1, GP2 emitted from the small lens 81A out of the plurality of small lenses 81 of the second lens array 80. The green light beam GP1 emitted from the entire region of the small lens 81A having a dimension dN toward the light modulation device 400G passes through the optical element 531 and forms an image in one pixel 402A out of the plurality of pixels 402 of the light modulation device 400G. The green light beam GP2 emitted toward the light modulation device 400G from any position of the small lens 81A as a point light source passes through the optical element 531 and enters the entire pixel 402A of the light modulation device 400G. The dimension of the pixel 402 on an axis crossing the optical axis of the green light GL incident on the light modulation device 400G, that is, the X axis or the Z axis is dP.

For example, the dimension of a region through which the green light beams GP1, GP2 pass in the optical element 531 on an axis crossing the optical axis of the green light GL, that is, the X axis or the Z axis is dW. A dimension of the blocking portion 512 of the optical element 531, through which the green light beams GP1, GP2 pass, on an axis crossing the optical axis, that is, the X axis or the Z axis is dS.

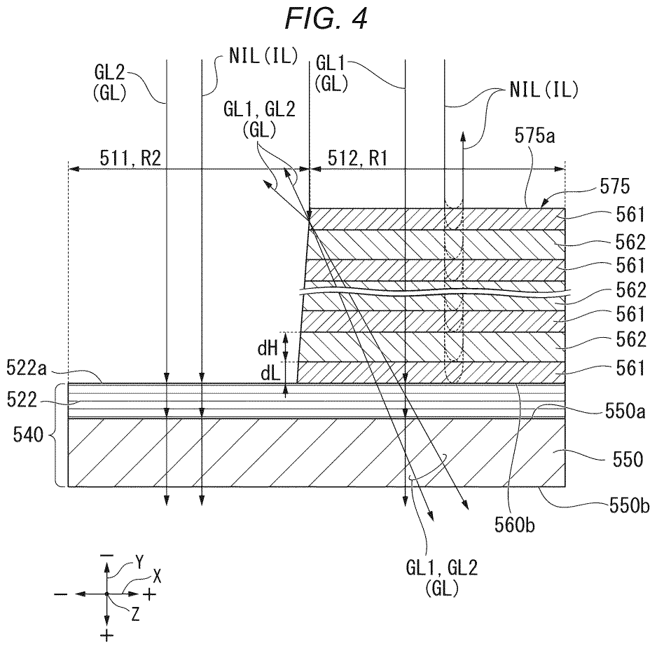

FIG. 4 is a cross-sectional view of an essential part of the optical element 531, and is a diagram viewed along the arrowed line IV-IV shown in FIG. 2. As shown in FIG. 4, the optical element 531 is configured with a substrate 550, a multilayer film 522, and a multilayer film 575. The substrate 550 and the multilayer film 522 are optical elements common to a first region R1 and a second region R2, and function as a substrate 540.

The substrate 550 has two plate surfaces 550a, 550b. The plate surface 550a is a surface at the −Y side that is parallel to a plane including the X axis and the Z axis. The plate surface 550b is a surface at the +Y side that is parallel to a plane including the X axis and the Z axis. The plate surface 550b corresponds to a first surface described later and a first surface set forth in the appended claims. The substrate 550 transmits the green light GL and the infrared light IL incident from the −Y side along the Y axis, and emits the green light GL and the infrared light IL toward the +Y side.

In the optical element 531, the green light GL corresponds to the first light described later and, corresponds to the first light set forth in the appended claims. The wavelength band of the green light GL corresponds to a first wavelength band described later, corresponds to a first wavelength band set forth in the appended claims, and is, for example, equal to or longer than 500 nm and equal to or shorter than 600 nm. In the optical element 531, the infrared light IL, that is, the near-infrared light NIL corresponds to second light described later, and corresponds to second light set forth in the appended claims. The wavelength band of the infrared light IL, that is, the near-infrared light NIL corresponds to a second wavelength band described later, corresponds to a second wavelength band set forth in the appended claims, and is, for example, equal to or longer than 900 nm and equal to or shorter than 1000 nm.

The substrate 550 is a light-transmissive substrate that transmits the green light GL having the wavelength in the first wavelength band described above and the infrared light IL having the second wavelength band described above, and is a substrate made of, for example, silicon dioxide (SiO₂).

The multilayer film 522 is formed at the plate surface 550a of the substrate 550, and is stacked at the −Y side of the substrate 550. The multilayer film 522 transmits substantially all the green light GL and the infrared light IL incident from the −Y side along the Y axis, and causes substantially all the green light GL and the infrared light IL to enter the substrate 550 from the −Y side. The multilayer film 522 acts as an antireflection film with respect to the substrate 550. The multilayer film 522 is, for example, a dielectric multilayer film configured with a high refractive index layer that is not shown and has a relatively high refractive index and a low refractive index layer that is not shown and is lower in refractive index than the high refractive index layer.

Note that a multilayer film that is not shown and is configured with a high refractive index layer and a low refractive index layer similarly to the multilayer film 522 may be formed at the plate surface 550b of the substrate 550. This multilayer film acts as an antireflection film similarly to the multilayer film 522.

The substrate 550 is zoned into a first region R1 acting as the blocking portion 512 and a second region R2 acting as the transmission portion 511 when viewed from the −Y side along the Y axis. A surface 522a of the multilayer film 522 on the substrate 550 is parallel to a plane including the X axis and the Z axis and is a surface at the −Y side.

The multilayer film 575 is formed at the surface 522a of the multilayer film 522 in the first region R1 and is stacked at the −Y side of the substrate 550. The multilayer film 575 transmits the green light GL incident from the −Y side along the Y axis and emits the green light GL toward the +Y side, and reflects the infrared light IL incident from the −Y side along the Y axis and emits the infrared light IL toward the −Y side.

The multilayer film 575 is a dielectric multilayer film configured with low refractive index layers 561 and high refractive index layers 562. Specifically, the multilayer film 575 is a film in which the low refractive index layers 561 and the high refractive index layers 562 are alternately stacked on one another along the Y axis.

The material of the low refractive index layer 561 is selected in accordance with the refractive index as the multilayer film 575, and is preferably any one of oxides, nitrides, and fluorides such as SiO₂.

The high refractive index layer 562 has a refractive index higher than that of the low refractive index layer 561 in the first wavelength band including the wavelength of the green light GL and the second wavelength band including the wavelength of the infrared light IL. The material of the high refractive index layer 562 is selected in accordance with a refractive index as the multilayer film 575 and the refractive index of the low refractive index layer 561, and is preferably any one of oxides, nitrides, and fluorides such as niobium pentoxide (Nb₂O₅).

A dimension dL of the low refractive index layer 561, that is, a size of the low refractive index layer 561 in the Y axis is appropriately set in accordance with the refractive index nL of the low refractive index layer 561 in the first wavelength band including the wavelength of the green light GL and the second wavelength band including the wavelength of the infrared light IL. Similarly, a dimension dH of the high refractive index layer 562, that is, a size of the high refractive index layer 562 in the Y axis is appropriately set in accordance with the refractive index nH of the high refractive index layer 562 in the first wavelength band including the wavelength of the green light GL and the second wavelength band including the wavelength of the infrared light IL.

The infrared light IL incident on the multilayer film 575 from the −Y side along the Y axis is multiply reflected by the interfaces between the low refractive index layers 561 and the high refractive index layers 562, which are alternately stacked on one another, and as a result, the infrared light IL is reflected toward the −Y side of the multilayer film 575 and is not emitted toward the +Y side of the multilayer film 575.

A green light beam GL1 incident on the first region R1 of the optical element 531 is transmitted through the blocking portion 512 and the first region R1. A green light beam GL2 incident on the second region R2 of the optical element 531 is transmitted through the transmission portion 511 and the second region R2. However, when the phase difference of at least a part of the green light beams GL1, GL2 scattered or diffracted by a peripheral edge or the like of the multilayer film 575 approaches about −180° or about 180°, the green light beams GL1, GL2 overlapping each other on the optical path weaken each other.

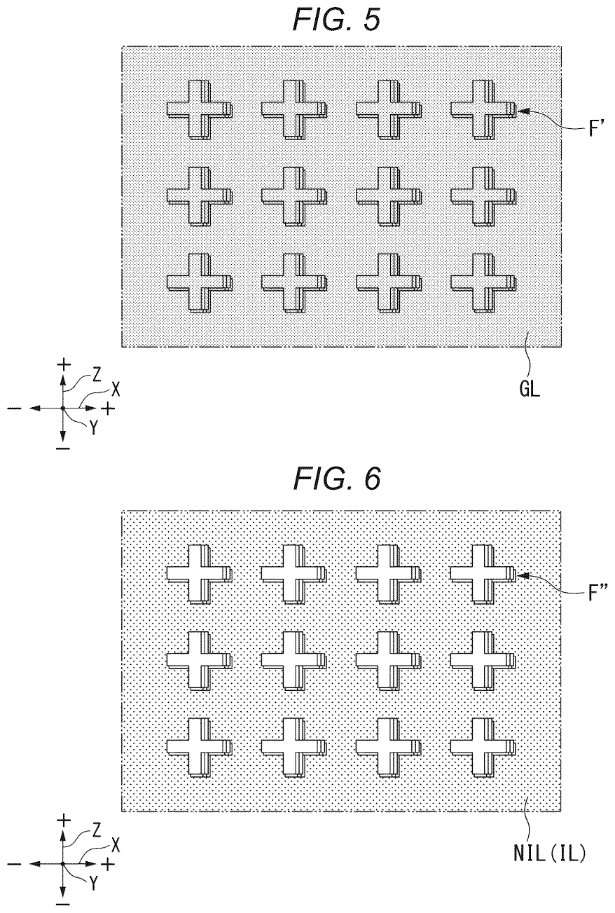

FIG. 5 is a schematic diagram of a part of an illuminance pattern in a plane including the X axis and the Z axis of the green light GL emitted from the optical element toward the +Y side along the Y axis in a related-art illumination optical system that includes an optical element having substantially the same configuration as the optical element 531 but does not satisfy a condition described later. As shown in FIG. 5, a pattern F′ is generated in the illuminance in a plane including the X axis and the Z axis of the green light GL emitted from the optical element toward the +Y side.

The pattern F′ is formed by deriving from the predetermined pattern F, and is a plurality of crisscross patterns overlapping the peripheral edges of the multilayer film 575 when viewed along the Y axis, and patterns slightly shifted from the peripheral edges respectively toward the −X side, the +X side, the −Z side, and the +Z side with the peripheral edges of the multilayer film 575 as the contours in accordance with the scattering direction and the diffraction direction of the green light beams GL1, GL2. In reality, the green light beams GL1, GL2 scattered or diffracted at the peripheral edge of the multilayer film 575 weaken each other as described above, so that the illuminance and the light intensity of the green light GL in the pattern F′ are lower than those in the periphery.

FIG. 6 is a schematic diagram of a part of an illuminance pattern in a plane including the X axis and the Z axis of the infrared light IL emitted from the optical element 531 toward the +Y side along the Y axis in the illumination device 601 including the optical element 531. In the illumination device 601, the Z axis with respect to the second lens array 80, the optical element 531, and the light modulation device 400G corresponds to a first axis described later and corresponds to a first axis set forth in the appended claims. The Y axis with respect to the second lens array 80 and the X axis with respect to the optical element 531 and the light modulation device 400G correspond to a second axis described later and correspond to a second axis set forth in the appended claims.

The infrared light IL incident on the optical element 531 is transmitted through the transmission portion 511 and the second region R2, but is reflected by the blocking portion 512 and the first region R1, and is blocked. As illustrated in FIG. 6, the illuminance in a plane including the X axis and the Z axis of the infrared light IL emitted from the optical element 531 toward the +Y side is lower in the blocking portion 512 and the entire second region R2 than in the transmission portion 511 and the first region R1. A pattern F″ is formed in the infrared light IL emitted from the optical element 531 toward the +Y side.

The pattern F″ is formed by deriving from the predetermined pattern F similarly to the pattern F′, and is a plurality of crisscross patterns overlapping regions occupied by the multilayer film 575 when viewed along the Y axis, and patterns in which the entire regions occupied by the multilayer film 575 are slightly shifted respectively toward the −X side, the +X side, the −Z side, and the +Z side in accordance with the scattering direction and the diffraction direction of the green light beams GL1, GL2. In reality, the green light beams GL1, GL2 scattered or diffracted at the peripheral edge of the multilayer film 575 weaken each other as described above, so that the illuminance and the light intensity of the green light GL in the pattern F″ are lower than those in the periphery.

As illustrated in FIG. 4, when viewed microscopically, in many cases, the peripheral edge of the multilayer film 575 is not parallel to a plane including the Y axis, but is slightly inclined with respect to the plane including the Y axis. By reducing the manufacturing error of the optical element and improving the processing accuracy, an angle of the peripheral edge of the multilayer film 575 with respect to a plane including the Y axis is reduced, and the occurrence of patterns with slight deviations in the X axis and the Z axis from the peripheral edges of the multilayer film 575 in the pattern F′ and display unevenness with the green light GL emitted from the optical element is suppressed. However, it has been confirmed that the pattern F′ and the display unevenness with the green light GL can be visually recognized even in a state where the peripheral edges of the multilayer film 575 of the optical element are substantially parallel to the plane including the Y axis and are hardly inclined with respect to the plane including the Y axis.

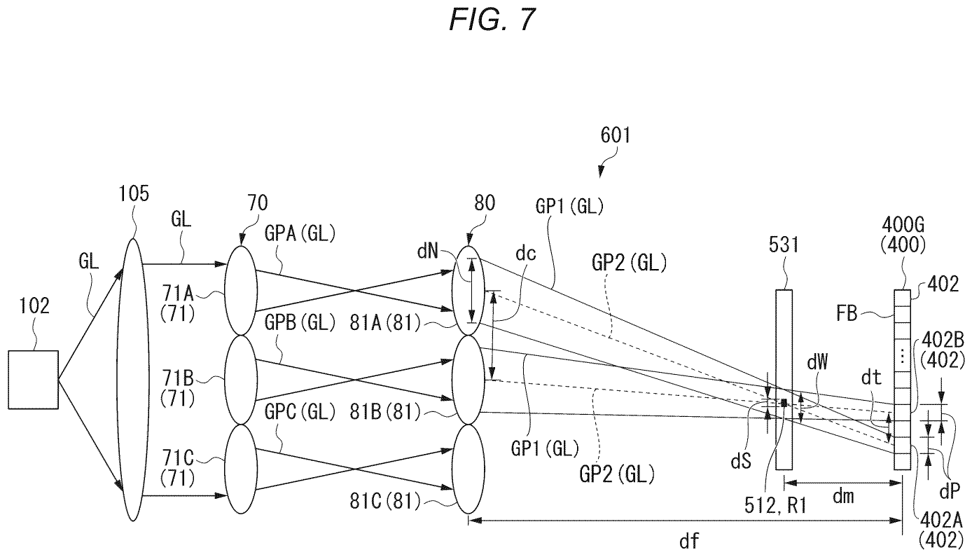

FIG. 7 is a schematic diagram of the illumination device 601 according to the first embodiment. FIG. 7 illustrates the green light beams GP1, GP2 emitted from the small lenses 81A, 81B out of the plurality of small lenses 81 of the second lens array 80. Regarding the green light beam GP2, only the center line is illustrated. As illustrated in FIGS. 3 and 7, in a side view, the blocking portion 512 in the region through which the green light beams GP1, GP2 pass in the optical element 531 is regarded as a point-like blocking portion 512 when viewed macroscopically. Therefore, a plurality of linear shadows appear on the modulation surface configured with the plurality of pixels 402 of the light modulation device 400G.

As illustrated in FIG. 7, a distance between the centers of the small lenses 81A, 81B on the axis crossing the optical axis of the green light GL in the white light WL incident on the second lens array 80, that is, the Y axis or the Z axis is dc. The dimension dW means a dimension on an axis crossing the optical axis, that is, the X axis or the Z axis of the irradiation region with the green light beams GP1, GP2 that are emitted from each of the small lenses 81A, 81B and pass through the optical element 531. A distance on the X axis or the Z axis between the center of the pixel 402A on which the green light beams GP1, GP2 emitted from the small lens 81A are incident and the center of the pixel 402B on which the green light beams GP1, GP2 emitted from the small lens 81B are incident is dt.

Based on a similarity relationship, the following relational expression is established among the distance dc between the small lenses 81A, 81B, the distance dt between the pixels 402A, 402B, the distance df between the second lens array 80 and the light modulation device 400G, and the distance dm between the optical element 531 and the light modulation device 400G.

dt=(dc×dm)/(df−dm) In reality, an optical element such as a lens or a mirror (not illustrated) may be disposed between the second lens array 80 and the light modulation device 400G in some cases, and the distance dc is appropriately corrected in consideration of the magnification of the lens or the thickness of the mirror. Since the green light GL that forms an image on the pixel 402 of the light modulation device 400G has an angular distribution around the optical axis, strictly speaking, the green light GL has predetermined dimensions in the X axis and the Z axis on the modulation surface of the light modulation device 400G, and causes blurring. In the present specification, it is assumed that the green light GL for forming an image on the pixel 402 of the light modulation device 400G forms a macroscopically clear linear image.

With reference to FIG. 4, the peripheral edge of the multilayer film 575 of the optical element 531 is inclined with respect to the plane including the Y axis, the width between an end at the −Y side and an end at the +Y side of the multilayer film 575 when viewed along the Y axis is on the order of micrometers, and is about 1 μm to 5 μm when the optical element 531 is manufactured based on a lift-off or etching technique, and is a part of the dimension dS. With reference to FIG. 3, the dimension dP of the pixel 402 of the light modulation device 400G is on the order of micrometers. The dimension dS of the peripheral edge of the multilayer film 575 is comparable to the dimension dP of the pixel 402 or no larger than the dimension dP.

Hereinafter, there will be described when the dimension dS of the peripheral edge of the multilayer film 575 is equal to or smaller than the dimension dP of the pixel 402, and the shadow by the green light GL passing through the optical element 531 is thinner than the pixel 402 of the light modulation device 400G. In the projector 11, the illuminance and the brightness of the green light GL per pixel displayed on the screen SCR are affected by integration values of the illuminance and the brightness of the green light GP incident on each of the pixels 402 of the light modulation device 400G from the plurality of small lenses 81 of the second lens array 80.

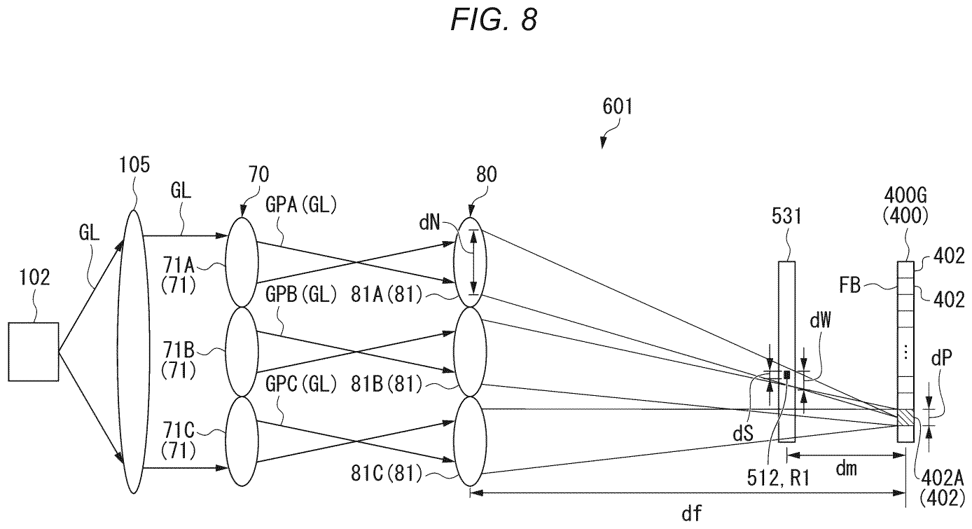

Here, a configuration example [1] in which the blocking portion 512 of the optical element 531 and the pattern F formed on the optical element 531 are disposed at the center on the Z axis when viewed from the −Y side along the Y axis and extend from an end at the −X side to an end at the +X side of the optical element 531 along the X axis will be considered. FIG. 8 is a schematic diagram of the configuration example [1] of the illumination device 601 of the first embodiment. As illustrated in FIG. 8, in the configuration example [1], the plurality of small lenses 81 is arranged side by side in a vertical direction in the sheet of the drawing, that is, in a direction along the Z axis, whereas the peripheral edge of the multilayer film 575 of the optical element 531 extends in a depth direction orthogonal to a direction in which the plurality of small lenses 81 is arranged side by side in the sheet of the drawing, that is, in a direction along the X axis.

In the configuration example [1], an interval between the shadows by the green light GL passing through the optical element 531 is equal to the dimension of the width of the linear image in the light modulation device 400G and is the distance dt. When viewed along the X axis when the dimension of the linear image of the green light beam GP1 in the light modulation device 400G and the distance dt are larger than the dimension dP of the pixel 402, the green light beam GP1 emitted from each of the plurality of small lenses 81 of the second lens array 80 and passing through the optical element 531 includes the green light beam GP1 that includes the blocking portion 512 in the optical path and the green light beam GP1 that does not include the blocking portion 512 in the optical path.

As described above, since the illuminance and the brightness of the green light GL in each pixel 402 of the light modulation device 400G depend on the integration values of those of the green light beams GP1 incident on the pixel 402, in the configuration example [1], a decrease in the brightness and the illuminance unevenness of the green light GL in a plane including the X axis and the Z axis due to the shadow by the green light GL passing through the optical element 531 are less likely to be visually recognized.

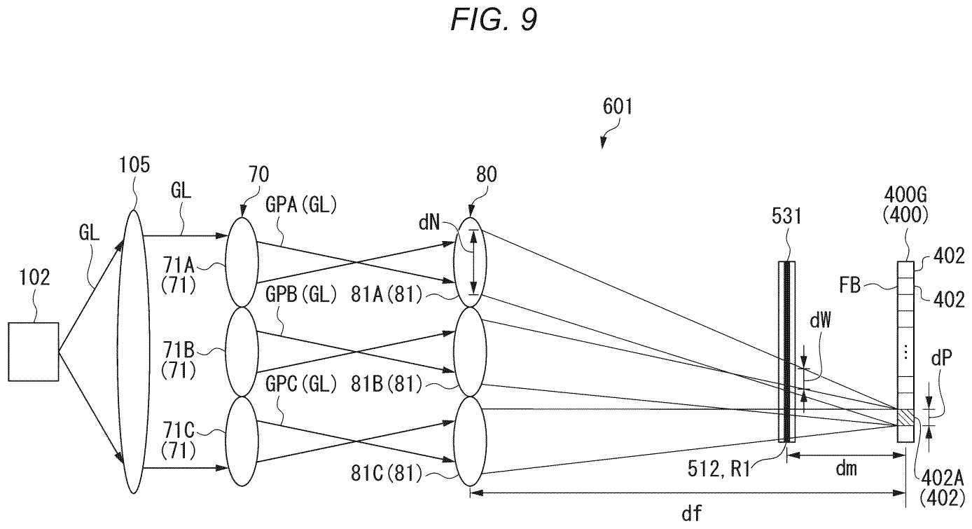

Then, a configuration example [2] in which the blocking portion 512 of the optical element 531 and the pattern F formed on the optical element 531 are disposed at the center on the X axis when viewed from the −Y side along the Y axis and extend from an end at the −Z side to an end at the +Z side of the optical element 531 along the Z axis will be considered. FIG. 9 is a schematic diagram of the configuration example [2] of the illumination device 601 of the first embodiment. As illustrated in FIG. 9, in the configuration example [2], the plurality of small lenses 81 is arranged side by side in a vertical direction in the sheet of the drawing, that is, in a direction along the Z axis, whereas the peripheral edge of the multilayer film 575 of the optical element 531 extends in a longitudinal direction parallel to the direction in which the plurality of small lenses 81 is arranged side by side in the sheet of the drawing, that is, in a direction along the Z axis.

In the configuration example [2], the light intensity of the green light GP incident on any pixel 402 out of the plurality of pixels 402 of the light modulation device 400G is affected by the blocking portion 512 of the optical element 531 and is smaller compared to the configuration example [1]. In the configuration example [2], due to the influence of the plurality of small lenses 81 of the second lens array 80, the illuminance unevenness along the peripheral edge of the blocking portion 512 of the optical element 531 is less likely to be visually recognized compared to the configuration example [1].

As an example, the second lens array 80 includes the small lenses 81 arranged in seven rows along the Z axis and arranged in nine rows along the X axis. For simplicity, when it is assumed that the light intensities of the green light beams GP1, GP2 emitted from the plurality of small lenses 81 are uniform among the small lenses 81, in the configuration example [2], the darkness of one shadow by the green light GL is reduced compared to the configuration example [1], and nine linear shadows that have the darkness reduced to 1/9 and partially overlap each other are visually recognized.

Note that determination on whether the eyes of the observer can visually recognize the illuminance unevenness with the visible light including the green light GL is based on, for example, the color difference ΔE*_{ab} in the L*a*b* color space. Assuming that there is no change in color due to the blocking portion 512 of the optical element 531 based on the L*a*b* color space, it is conceivable that as long as the color difference ΔE*_{ab} is 0.8 or less, the color difference in the visible light as an observation target is hardly visually recognized, and the brightness of the visible light decreases by about 2%.

Based on the behaviors of the green light GL in the configuration examples [1] and [2] described above, in the illumination device 601 of the first embodiment, in order to avoid a state in which the shadows by the green light GL overlap each other to increase the darkness compared to the surroundings, and the linear shadows and the display unevenness are likely to be visually recognized, measures are taken to make it difficult for the linear shadows by the green light GL to overlap each other. In the illumination device 601 of the first embodiment, for example, a pattern 1 or a pattern 2 described below may be applied.

### <Pattern 1: Condition Where Shadows Fail to Overlap at Angle Near to Angles of Vertical and Horizontal Lines>

The term vertical in the vertical and horizontal lines means a direction along the Z axis, and the term horizontal means a direction along the X axis. The shadow SD in the first embodiment has a linear shape when viewed along the Y axis. The darkness of a single linear shadow SD is affected by the integration values of the illuminance and the brightness of the green light GP incident on the pixel 402 of the light modulation device 400G from the plurality of small lenses 81 of the second lens array 80 as described above. The dimension of the shadow SD in the longitudinal direction is sufficiently larger than the dimension dP of the pixel 402, and is, for example, equal to or larger than a value obtained by multiplying the dimension dP by the total number of small lenses 81.

In one shadow SD, in reality, the same number of components of the pattern F and the peripheral edge of the multilayer film 575 along one direction in a plane including the X axis and the Z axis as the total number of small lenses 81 may be coupled to one another. As in the pattern F illustrated in FIG. 2, the boundary between the first region R1 and the second region R2 of the optical element 531, that is, the peripheral edge of the multilayer film 575 includes a number of linear components parallel to the Z axis and a number of linear components parallel to the X axis. Therefore, one shadow SD along the Z axis includes a plurality of shadows so as to suppress the area of a region where shadows caused by a large number of linear components parallel to the Z axis overlap each other at the ends in the longitudinal direction. One shadow SD along the X axis includes a plurality of shadows so as to suppress the area of a region where shadows caused by a large number of linear components parallel to the X axis overlap each other at the ends in the longitudinal direction.

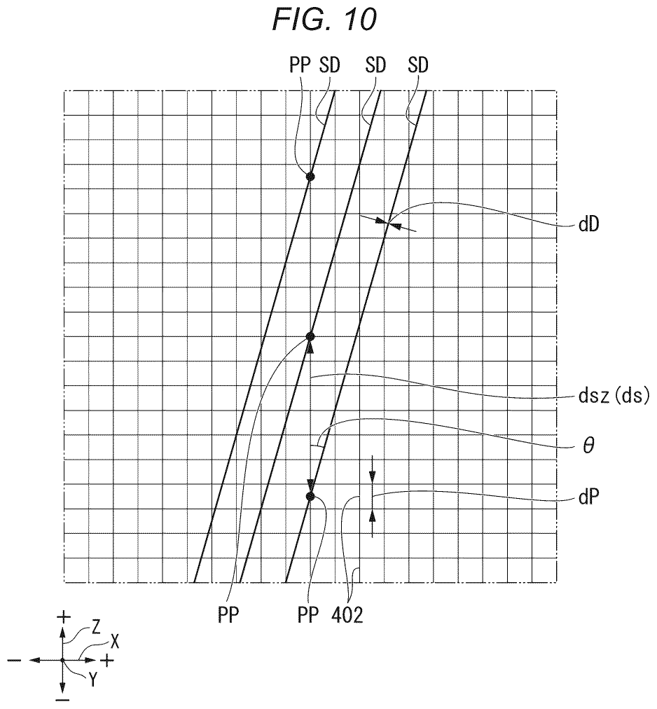

FIG. 10 is a schematic diagram of the shadow SD when the dimension of the width of the shadow SD by the green light GL on the modulation surface of the light modulation device 400G is smaller than the dimension of the pixel 402. FIG. 10 illustrates three shadows SD formed by the green light beams GP1 emitted from three small lenses 81 of the second lens array 80. In the pattern 1, for example, the shadows SD are inclined with respect to the Y axis so that a point on the shadow SD moves from the −Z side toward the +Z side as moving from the −X side toward the +X side. The angle formed by the shadow SD with respect to the Z axis is θ [deg.]. Any points PP on the three shadows that overlap each other in a direction along the Z axis are considered as the rotational centers in a plane including the X axis and the Z axis.

The width dimension of the shadow by the green light GL is dD. First, in a first configuration of the pattern 1 of the illumination device 601, it is assumed that the dimension dD of the width of the shadow SD by the green light GL is sufficiently smaller than the dimension dP of the pixel 402 of the light modulation device 400G and is at least 1/10 or less of the dimension dP, and the dimension dD is zero for simplicity. When the contour of the shadow SD is blurred by the illumination optical system of the illumination device 601 and it is difficult to clearly define the dimension dD, it is sufficient to define the dimension dD in consideration of the light intensity distributions of the green light GL and the visible light with which the optical element 531 is irradiated. For example, the light intensity distribution of the shadow SD by the green light GL formed by each of the small lenses 81 of the second lens array 80 may be approximated to an appropriate function, and the dimension of the half width, the 1/e width, the 1/e² width, or the 1/10 width with respect to the peak or the bottom of the function may be adopted as the dimension dD.

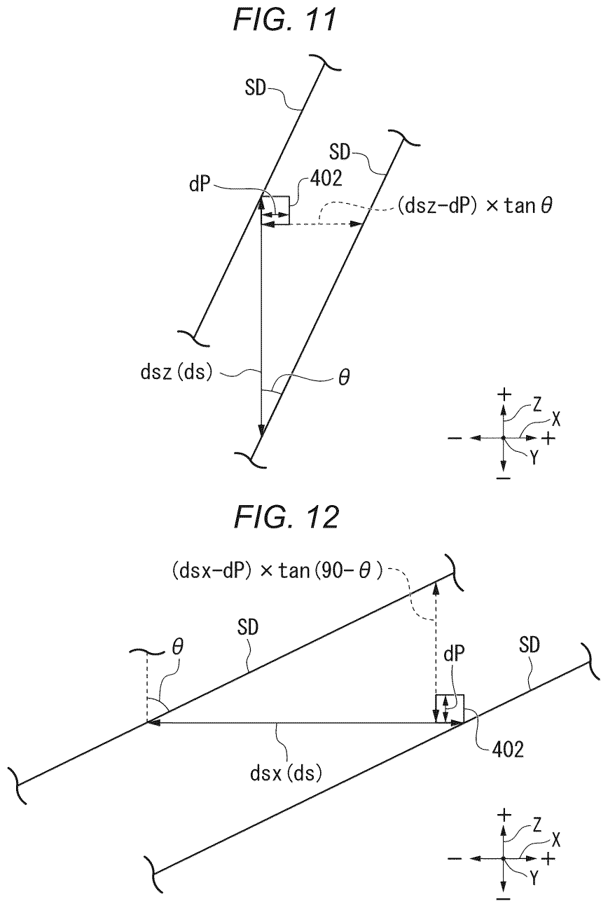

When the extending direction of the linear shadow SD is inclined with respect to the Z axis when viewed along the Y axis, the shadow SD rotates by the angle θ with respect to the Z axis from the positional relationship between the second lens array 80 and the peripheral edge of the multilayer film 575 of the optical element 531. The ratio of the diameter on the Z axis to the diameter on the Y axis of the small lens 81 of the second lens array 80 is defined as a:b. FIGS. 11 and 12 are enlarged views of a part of FIG. 10, and are schematic diagrams of a region including a part of two shadows SD out of the three shadows SD and the pixel 402 located between the two shadows SD in the first configuration of the pattern 1.

As illustrated in FIG. 11, when the angle θ is equal to or smaller than 45°, that is, when the shadows SD are projected in a substantially vertical direction on the modulation surface of the light modulation device 400, a distance on the Z axis between the two shadows SD adjacent to each other in a plane including the X axis and the Z axis is defined as dsz. In this case, when (dsz-dP)×tan θ is greater than the dimension dP, the shadows SD do not overlap each other in any pixel 402 of the light modulation device 400G. The distance dsz corresponds to a distance between the center lines of the two shadows SD adjacent to each other at the imaging surface FB described later, corresponds to a distance ds between the center lines of the two shadows adjacent to each other on the imaging surface FB set forth in the appended claims, and is a component on the Z axis of the distance ds.

As illustrated in FIG. 12, when the angle θ is larger than 45°, that is, when the shadows SD are projected in a substantially horizontal direction on the modulation surface of the light modulation device 400, an interval, that is, a distance on the X axis between the two shadows SD adjacent to each other in a plane including the X axis and the Z axis is defined as dsx. In this case, when (dsx-dP)×tan(90−θ) is greater than the dimension dP, the shadows SD do not overlap each other in any pixel 402 of the light modulation device 400G.

By summarizing the design policies obtained in the two cases described above, the following formula (1) is obtained. In the formula (1), the angle θ is 0° or more and 90° or less.

$${tan}^{- 1} ( \frac{dP}{dsz - dp} ) < θ < {tan}^{- 1} ( \frac{dsx - dP}{dP} ) \qquad ( 1 )$$

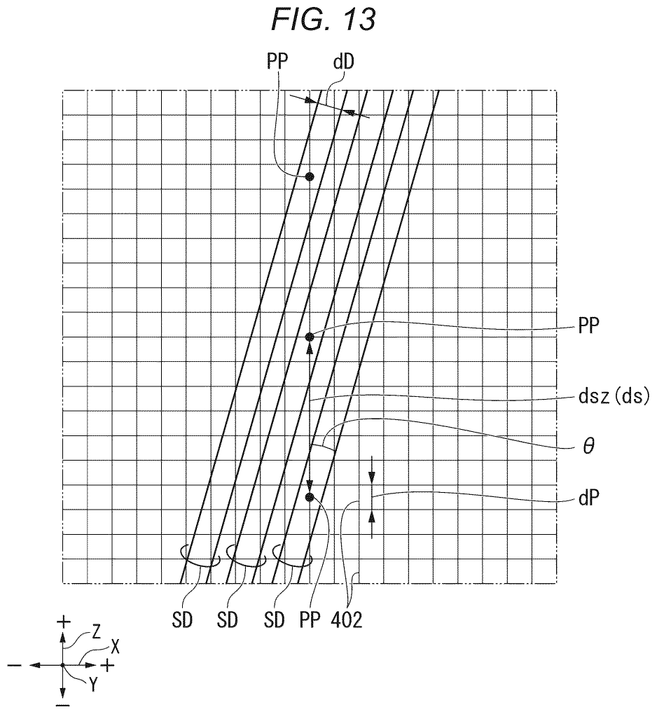

Then, in a second configuration of the pattern 1 of the illumination device 601, it is assumed that the dimension dD of the width of the shadow SD by the green light GL is larger than the dimension dP of the pixel 402 of the light modulation device 400G. In the second configuration, the dimension dD of the shadow SD is sufficiently smaller than the distances dsz, dsx between the shadows SD, and is strictly equal to or smaller than a value obtained by multiplying 1/sqrt(2) by the distances dsz, dsx when dsz=dsx. The characters sqrt(2) represent the square root of 2. FIG. 13 is a schematic diagram of the shadow SD when the dimension of the width of the shadow SD by the green light GL on the modulation surface of the light modulation device 400G is equal to or larger than the dimension of the pixel 402. FIG. 13 also illustrates three shadows SD formed by the green light beams GP1 emitted from the three small lenses 81 of the second lens array 80.

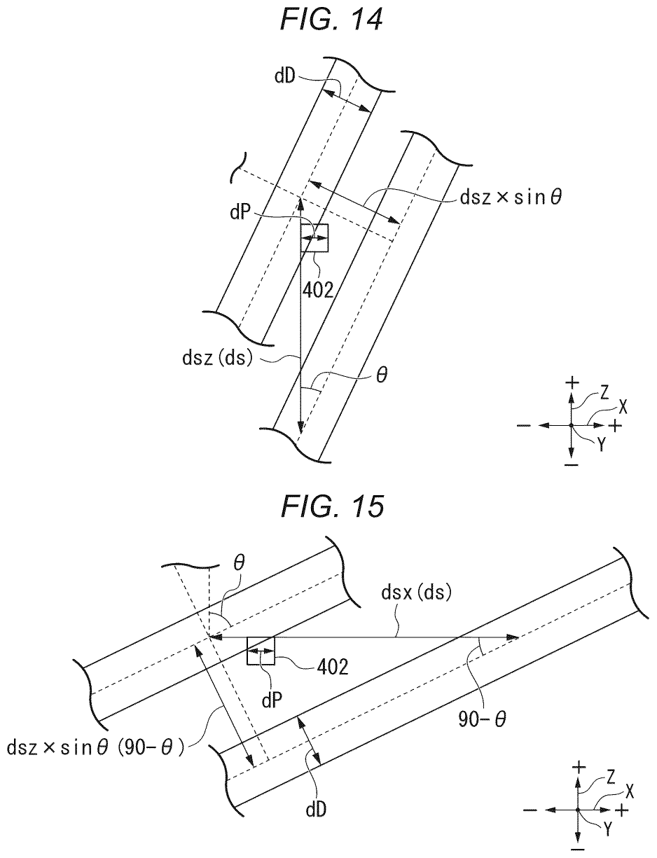

In the second configuration, similarly to the first configuration, when the distance between the shadows SD adjacent to each other in a plane including the X axis and the Z axis is larger than the dimension dD, the shadows SD do not overlap each other. FIGS. 14 and 15 are enlarged views of a part of FIG. 13, and are schematic diagrams of a region including a part of two shadows SD out of the three shadows SD and the pixel 402 located between the two shadows SD in the second configuration of the pattern 1.

As illustrated in FIG. 14, when the angle θ is equal to or less than 45°, that is, when the shadows SD are projected in a substantially vertical direction on the modulation surface of the light modulation device 400, when the distance on the Z axis between the two shadows SD adjacent to each other in a plane including the X axis and the Z axis is defined as dsz, a distance between the centers of the two shadows SD adjacent to each other is obtained as dsz×sin θ. In this case, when dsz×sin θ is larger than the dimension dD to satisfy dsz×sin θ>dD, the shadows SD do not overlap each other in any pixel 402 of the light modulation device 400G.

As illustrated in FIG. 15, when the angle θ is larger than 45°, that is, when the shadows SD are projected in a substantially horizontal direction on the modulation surface of the light modulation device 400, when an interval, that is, a distance on the X axis between the two shadows SD adjacent to each other on a plane including the X axis and the Z axis is defined as dsx, the distance between the centers of the two shadows SD adjacent to each other is obtained as dsx×sin(90−θ), that is, dsx×cos θ. In this case, when dsx×cos θ is larger than the dimension dD to satisfy dsx×cos θ>dD, shadows do not overlap each other in any pixel 402 of the light modulation device 400G. The distance dsx corresponds to a distance between the center lines of the two shadows SD adjacent to each other at the imaging surface FB described later, corresponds to a distance ds between the center lines of the two shadows adjacent to each other on the imaging surface FB set forth in the appended claims, and is a component on the X axis of the distance ds.

By summarizing the design policies obtained in the two cases described above, the following formula (2) is obtained. In the formula (2), the angle θ is 0° or more and 90° or less.

$${sin}^{- 1} ( \frac{dD}{dsz} ) < θ < {cos}^{- 1} ( \frac{dD}{dsx} ) \qquad ( 2 )$$

### <Pattern 2: Condition Where Oblique Linear Shades Fail to Overlap>

When viewed in an incident direction of the green light GL on the optical element 531, that is, viewed along the Y axis, the plurality of small lenses 81 of the second lens array 80 is arranged in a matrix on a plane including the Y axis and the Z axis. In a pattern 2, the number of small lenses 81 arranged along the Z axis is m, the number of small lenses 81 arranged along the Y axis is n, and the ratio of the diameter on the Z axis of the small lens 81 to the diameter on the Y axis is a:b similarly to the pattern 1. The ratio a:b is equal to the ratio dsz:dsx.

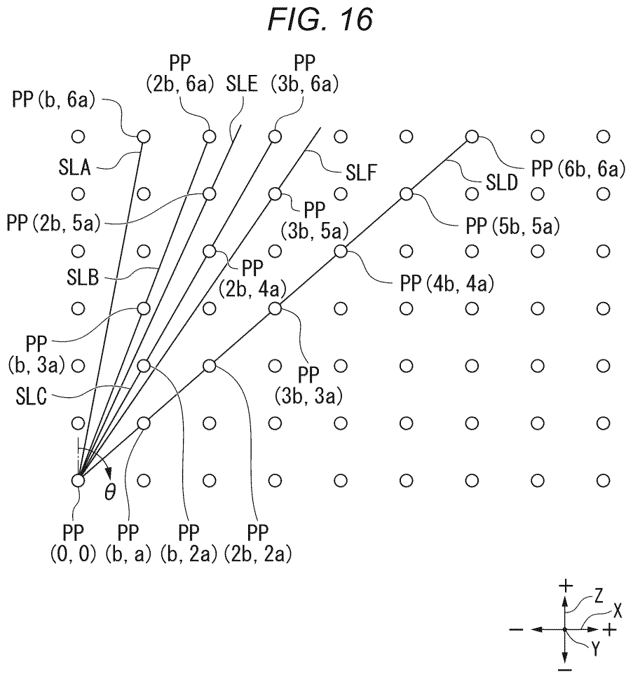

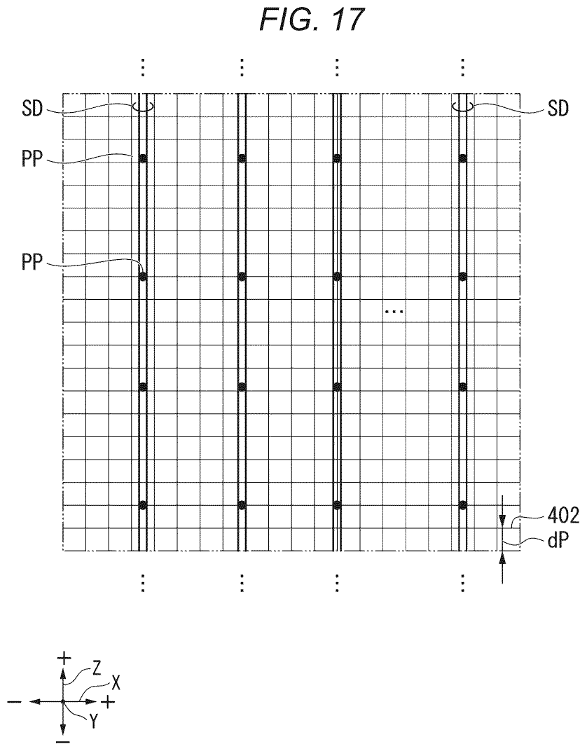

FIG. 16 is a schematic diagram illustrating a relative positional relationship in a plane including the X axis and the Z axis of the points PP which are the rotation centers of the plurality of shadows SD by the green light GL formed by the plurality of small lenses 81 of the second lens array 80. As illustrated in FIG. 16, when the point PP at the extreme −X side and the extreme −Z side within of the plurality of points PP is set to an origin, the gradient of a straight line SL passing through the origin, that is, the center line of the shadow SD passing through the origin is expressed by tan(90-θ). When the straight line SL passes through the origin and a point PP other than the origin, the two shadows SD overlap each other. That is, when the point PP of any one of the shadows SD is set as the origin, two shadows SD adjacent to each other in a plane including the X axis and the Z axis do not overlap each other unless the straight line SL of that shadow SD passes through the point PP of the other shadow SD. Based on this, a condition that when the point PP of any one of the shadows SD is set as the origin, the straight line SL of that shadow SD fails to pass through the point PP of the other shadow SD will be examined.

Constants k1, k2 having any values are introduced, and k1 is assumed to be a natural number no smaller than 1 and no larger than m−1, and k2 is assumed to be a natural number no smaller than 1 and no larger than n−1. The relative coordinates of the points PP in a plane including the X axis and the Z axis of the points PP of the plurality of shadows SD by the green light GL formed by the plurality of small lenses 81 are expressed as (k2×b, k1×a). The gradient of the straight line SL passing through the point PP that is the origin and the point PP other than the origin is tan(90-0) as described above, and is expressed as (k1×a)/(k2×b). Therefore, a preferable condition satisfied by the angle θ is expressed by the following formula (3).

$${tan}^{- 1} ( \frac{k 1 \cdot a}{k 2 \cdot b} ) \neq θ \qquad ( 3 )$$

In particular, when (k1×a)=(k2×b) is satisfied, all the shadows by the green light GL emitted from the plurality of small lenses 81 overlap each other, the shadows SD and the illuminance unevenness become apparent on the modulation surface of the light modulation device 400G, and the pattern F′ and the illuminance unevenness can be clearly visually recognized in the image light projected from the projector 11. Therefore, establishment of (k1×a)=(k2×b) should be avoided.

In reality, since the shadow SD has the width of the dimension dD, there is created the state in which the shadow SD having the center line along the straight line SL and the width of the dimension dD is inclined at the angle θ with respect to the Z axis. In the illumination device 601, in this state, in consideration of the dimensions dP of the plurality of pixels 402 of the light modulation device 400G, the number n of small lenses 81 of the second lens array 80 arranged along the X axis, the number m of small lenses 81 arranged along the Z axis, the ratio a:b of the diameter on the Z axis and the diameter on the Y axis of the small lens 81, the distance df between the second lens array 80 and the light modulation device 400G, and the distance dm between the optical element 531 and the light modulation device 400G are set to each other so as to satisfy the formula (3).

In the pattern 2, the smaller the number and the amount of shadows overlapping each other, the more the actualization of the shadow SD and the illuminance unevenness on the modulation surface of the light modulation device 400G are suppressed. In the configuration of the pattern 2 of the illumination device 601, the second lens array 80 having m×n small lenses 81 is used, and the largest number of shadows overlap each other when m shadows overlap each other. The number m is a natural number no smaller than 2. That is, in the pattern 2, a smaller number of shadows than m may overlap at the modulation surface of the light modulation device 400G as long as the design policy of the illumination device 601 of the first embodiment is satisfied.

In the illumination device 601, in order to enhance the uniformity of the green light GL incident on the modulation surface of the light modulation device 400G, the total number m×n of small lenses 81 of the second lens array 80 is preferably set to an odd number.

As an example, when m=7 and n=9 are set as illustrated in FIG. 16 will be described. In this case, m−1 is 6, and a common divisor of m−1 is 1, 2, 3, and 6. When the straight line SL related to the shadow SD passes through the point PP formed on the outermost periphery in a plane including the X axis and the Z axis in addition to the point PP as the origin, straight lines SLA, SLB, SLC, and SLD are assumed.

The straight line SLA passes through the point PP that is the origin and has a relative coordinate (0, 0) and the point PP that has a relative coordinate (b, 6a). In this case, two shadows overlap each other. The straight line SLB passes through the point PP that has a relative coordinate (0, 0), the point PP that has a relative coordinate (b, 3a), and the point PP that has a relative coordinate (2b, 6a). In this case, three shadows overlap each other. The straight line SLC passes through the point PP having a relative coordinate (0, 0), the point PP that has a relative coordinate (b, 2a), the point PP that has a relative coordinate (2b, 4a), and the point PP that has a relative coordinate (3b, 6a). In this case, four shadows overlap each other.

The straight line SLD passes through the point PP that has a relative coordinate (0, 0), the point PP that has a relative coordinate (b, a), the point PP that has a relative coordinate (2b, 2a), the point PP that has a relative coordinate (3b, 3a), the point PP that has a relative coordinate (4b, 4a), the point PP that has a relative coordinate (5b, 5a), and the point PP that has a relative coordinate (6b, 6a). In this case, seven shadows overlap each other, and a state in which the largest number of shadows overlap each other occurs when m=7 and n=9 are satisfied in the configuration of the pattern 2 of the illumination device 601. A condition for avoiding the state in which the largest number of shadows overlap each other is expressed by the following formula (4).

$${tan}^{- 1} ( \frac{a}{b} ) \neq θ \qquad ( 4 )$$

When the straight line SL related to the shadow SD does not pass through the point PP formed on the outermost periphery in the plane including the X axis and the Z axis in addition to the point PP which is the origin, for example, straight lines SLE and SLF are assumed. The straight line SLE passes through the point PP that has the relative coordinate (0, 0) and the point PP that has a relative coordinate (2b, 5a). The straight line SLF passes through the point PP that has the relative coordinate (0, 0) and the point PP that has a relative coordinate (3b, 5a). In these cases, two shadows overlap each other.

Note that, although related to the description presented later and not shown in the drawings, when θ=90° is satisfied, and the straight line SL related to the shadow SD passes through the point PP that has the relative coordinate (0, 0), the point PP that has the relative coordinate (b, 0), the point PP that has the relative coordinate (2b, 0), the point PP that has the relative coordinate (3b, 0), the point PP that has the relative coordinate (4b, 0), the point PP that has the relative coordinate (5b, 0), the point PP that has the relative coordinate (6b, 0), the point PP that has the relative coordinate (7b, 0), and the point PP that has the relative coordinate (8b, 0) corresponds to the behavior of the shadow SD in the illumination device to which the design policy of the pattern 2 described above is not applied.

### <When Design Policies of Pattern 1 and Pattern 2 are not Applied>

FIG. 17 is a schematic diagram of the shadow SD when the dimension of the width of the shadow SD by the green light GL on the modulation surface of the light modulation device 400G is equal to or larger than the dimension of the pixel 402. In reality, the same number and the same amount of shadows as the total number of small lenses 81 of the second lens array 80 are projected on the modulation surface of the light modulation device 400G. When the total number of small lenses 81 of the second lens array 80 is m×n as in the example described above, n shadows are formed along the X axis, and m shadows are formed along the Z axis.

As illustrated in FIG. 17, in one shadow SD, the m shadows by the green light GL extending along the Z axis partially overlap each other and are coupled along the Z axis. On the X axis, the n shadows SD are formed at intervals. In the modulation surface of the light modulation device 400G configured with the plurality of pixels 402, the green light GL is incident on the individual pixels 402 at all angles from the horizontal direction, that is, the −X side and the +X side on the X axis, and the decrease in illuminance and brightness of the green light GL is suppressed. On the other hand, since the shadow SD extends along the vertical direction, that is, the Z axis, the plurality of shadows caused by the green light GL from the plurality of small lenses 81 overlap each other in at least end portions at the +Z side and end portions at the −Z side. The region where the plurality of shadows by the green light GL overlaps each other is darker than the surroundings, becomes apparent, and is likely to be visually recognized. The illuminance of the region where the plurality of shadows by the green light GL overlap each other is lower than that of the surroundings.

When the design policies of the pattern 1 and the pattern 2 are not applied and (k1×a)=(k2×b) is satisfied in relation to the formula (3), the shadow SD becomes apparent as described above, and it is difficult to suppress the occurrence of the illuminance unevenness on the modulation surface of the light modulation device 400G.

### SUMMARY

The illumination device 601 according to the first embodiment described above includes the light emitting element (first light source) 102 of the light source device 100, the collimating element 105, the light emitting elements (second light source) 152 of the light source device 150, the optical element 531, and the second lens array (lens array) 80, and further includes the first lens array 70. The light emitting element 102 emits the white light WL including the green light (first light) GL having the wavelength in the green wavelength band (first wavelength band) which is the visible wavelength band. The collimating element 105 collimates the green light GL emitted from the light emitting element 102. The light emitting elements 152 emit the infrared light (second light) IL having the wavelength in the infrared wavelength band (second wavelength band) that is the invisible wavelength band different from the green wavelength band toward the optical path of the green light GL emitted from the collimating element 105. Specifically, the infrared light IL emitted from the light emitting elements 152 travels, for example, from the −Y side toward the +Y side along the Y axis, and is then superimposed on at least a part of the green light GL that is emitted from the light emitting element 102, then passes through the second lens array 80, and is then reflected by the dichroic mirror 220, and then travels from the −Y side toward the +Y side along the Y axis. The optical element 531 is disposed on the optical path of the green light GL emitted from the collimating element 105 and the infrared light IL emitted from the light emitting elements 152. The second lens array 80 is disposed between the collimating element 105 and the optical element 531 in the optical path of the green light GL. The first lens array 70 is disposed between the collimating element 105 and the second lens array 80 in the optical path of the green light GL.

In the illumination device 601 of the first embodiment, the second lens array 80 includes the plurality of small lenses 81. The imaging surface FB of the green light GL incident on the small lens 81 is located closer to the exit side of the light emitting element 102 than the optical element 531 in the optical path of the green light GL. In the second lens array 80, the m small lenses 81 are arranged along the Z axis (first axis) contained in a plane crossing the optical axis of the incident green light GL, that is, the Y axis and including the X axis and the Z axis, and the n small lenses 81 are arranged along the X axis (second axis) orthogonal to the Z axis. The number m is a natural number no smaller than 2, and the number n is a natural number no smaller than m.

In the illumination device 601 of the first embodiment, the optical element 531 is zoned into the first region R1 and the second region R2 when viewed along the optical axis AX20 of the green light GL incident thereon. In the first region R1, the green light GL is transmitted, and the infrared light IL is blocked by, for example, being reflected or absorbed. In the second region R2, both the green light GL and the infrared light IL are transmitted. In the illumination device 601 of the first embodiment, the distance df in the optical path of the green light GL between the second lens array 80 and the imaging surface FB, the distance dm in the optical path of the green light GL between the optical element 531 and the imaging surface FB, the natural numbers m, n, the ratio between the diameter on the Z axis and the diameter on the Y axis of the small lens 81, and the number of first regions R1 and blocking portions 512, the maximum dimension in the plane including the X axis and the Z axis, and the distance between the first region R1 and the blocking portion 512 in the optical element 531 are set such that the green light GL that is emitted from the plurality of small lenses 81 of the second lens array 80, and is incident on the optical element 531, and passes through the peripheral edge of the first region R1 is projected onto the imaging surface FB to thereby cause a smaller number of shadows than n by the green light GL to overlap each other on the imaging surface FB.

Note that in the first embodiment, the description is presented with a focus on when the m small lenses 81 are arranged along the vertical direction, that is, the Z axis when viewed along the direction in which the green light GL is incident on the second lens array 80, that is, the X axis. In reality, when the n×m small lenses 81 are two-dimensionally arranged in a plane including the Y axis and the Z axis, the vertical direction of the second lens array 80 in the description of the illumination device of the first embodiment may be converted into the horizontal direction, the Z axis may be converted into the Y axis, and the dimensions and distances corresponding to each direction and each axis may appropriately be converted. In the same case, the vertical direction of the modulation surface, that is, the imaging surface FB of the light modulation device 400G in the description of the illumination device of the first embodiment may be converted into the horizontal direction, the Z axis may be converted into the X axis, and the dimensions and the distances corresponding to each direction and each axis may appropriately be converted. As a result, in the second lens array 80, when the n×m small lenses 81 are two-dimensionally arranged in a plane including the Y axis and the Z axis, and n is a natural number no smaller than m, as described in the first embodiment, the condition in which a smaller number of shadows SD than m may overlap each other in the vertical direction is applied as a condition in which a smaller number of shadows than n by the green light GL overlap each other on the imaging surface FB. In the illumination device 601 of the first embodiment, the distances df, dm, the natural numbers m, n, the ratio between the diameter on the Z axis and the diameter on the Y axis of the small lens 81, and the number of first regions R1 and blocking portions 512, the maximum dimension on the plane including the X axis and the Z axis, and the distance between the first region R1 and the blocking portion 512 in the optical element 531 are appropriately set based on the design policy and the condition applied as the condition in which a smaller number of shadows than n by the green light GL overlap each other on the imaging surface FB.

In the illumination device 601 according to the first embodiment, the green light GL emitted from the light emitting element 102 passes through the plurality of small lenses 81 of the second lens array 80, then passes through the first region R1 and the second region R2 of the optical element 531, and then forms an image on the imaging surface FB. The infrared light IL emitted from the light emitting elements 152 is blocked by the first region R1 of the optical element 531 disposed between the second lens array 80 and the imaging surface FB in the optical path of the green light GL while being transmitted through the second region R2, and is blocked in accordance with the first region R1 on the imaging surface FB to form the pattern F″ with the infrared light IL. According to the illumination device 601 of the first embodiment, the spectral characteristics are imparted to the first region R1 due to the difference in behavior between the green light GL and the infrared light IL in the first region R1 of the optical element 531. According to the illumination device 601 of the first embodiment, the imaging surface FB is illuminated with the green light GL that does not include the predetermined pattern F and the infrared light IL that includes the pattern F″ according to the predetermined pattern F.

In the illumination device 601 of the first embodiment, the green light beam GL1 is incident on the first region R1 of the optical element 531 from the −Y side along the Y axis, and the green light beam GL2 is incident on the second region R2 from the −Y side along the Y axis, but a small part of the green light beams GL1, GL2 is scattered or diffracted at the boundary between the first region R1 and the second region R2, that is, the peripheral edge of the multilayer film 575. Since the green light beams GL1, GL2 scattered or diffracted at the peripheral edge of the multilayer film 575 weaken each other due to the phase difference between the green light beams GL1, GL2, the peripheral edge of the multilayer film 575 may form a shadow by the green light GL that illuminates the imaging surface FB from each of the small lenses 81 of the second lens array 80. In the illumination device 601 of the first embodiment, the distances df, dm, the natural numbers m, n, and the ratio between the diameter on the Z axis and the diameter on the X axis of the small lens 81 are appropriately set in accordance with the relative positions and the pattern F of the boundaries between the first regions R1 and the second region R2 in the plane including the X axis and the Z axis, that is, the peripheral edges of the multilayer film 575 so that a smaller number of shadows than n by the green light GL overlap each other on the imaging surface FB. In the related-art illumination device, parameters such as the distances df, dm, the natural numbers m, n, and the ratio between the diameter on the Z axis and the diameter on the X axis of the small lens 81 are set without considering the conditions described above, and there is a possibility that illuminance unevenness due to a portion where n or more shadows by the green light GL overlap each other on the imaging surface FB becomes apparent. According to the illumination device 601 of the first embodiment, since a smaller number of shadows than n by the green light GL overlap each other on the imaging surface FB, it is possible to suppress the illuminance difference of the green light GL on the imaging surface FB to suppress the actualization of the illuminance unevenness of the green light GL and the color difference ΔE*_{ab} of the visible light including the green light GL, and the visibility of the pattern F″ according to the pattern F.

The illumination device 601 according to the first embodiment further includes the light modulation device (image processing device) 400 having the modulation surface (processing surface). The modulation surface of the light modulation device 400 includes a plurality of pixels 402 and is disposed at the imaging surface FB in the optical path of the green light GL. When the dimensions on the Z axis and the X axis of the pixel 402 are defined as dP and the distance between the center lines of two shadows (two shadows) SD adjacent to each other at the imaging surface FB is defined as ds, dP<ds is satisfied.

In the illumination device 601 according to the first embodiment, the shadow SD linearly formed on the imaging surface FB including the X axis and the Z axis includes a plurality of shadows formed by the green light GL emitted from the plurality of small lenses 81 of the second lens array 80. According to the illumination device 601 of the first embodiment, even when the distance ds between the linear shadows SD adjacent to each other on the imaging surface FB is larger than the dimension dP of the pixel 402 of the light modulation device 400G, it is possible to prevent the shadows SD from overlapping each other to suppress the illuminance difference of the green light GL on the imaging surface FB, and to reduce the illuminance unevenness of the green light GL.

In the illumination device 601 according to the first embodiment, the plurality of pixels 402 of the light modulation device 400G are arranged along at least one of the Z axis and the X axis, and are arranged, for example, two-dimensionally along the Z axis and the X axis. The shadow by the green light GL emitted from the plurality of small lenses 81 of the second lens array 80 and the shadow SD are linearly formed on the imaging surface FB. The dimension dD of the width of the shadow SD is sufficiently smaller than the dimension dP of the pixel 402 and is equal to or smaller than 1/10 of the dimension dP. In the illumination device 601 of the first embodiment, when the angle θ formed by the center line of the shadow SD with respect to the Z axis is 0° or more and 90° or less, the formula (1) is satisfied.

$${tan}^{- 1} ( \frac{dP}{dsz - dp} ) < θ < {tan}^{- 1} ( \frac{dsx - dP}{dP} ) \qquad ( 1 )$$

In the illumination device 601 of the first embodiment, by satisfying the formula (1), it is possible to avoid a state in which the shadows by the green light GL formed by the plurality of small lenses 81 of the second lens array 80 are arranged along the Z axis or the X axis and the plurality of shadows overlap each other. According to the illumination device 601 of the first embodiment, it is possible to suppress the illuminance difference of the green light GL on the imaging surface FB and reduce the illuminance unevenness of the green light GL by avoiding a state in which the overlap between the shadows becomes apparent.

In the illumination device 601 according to the first embodiment, similarly to the above, the plurality of pixels 402 of the light modulation device 400G are arranged along at least one of the Z axis and the X axis, and are arranged, for example, two-dimensionally along the Z axis and the X axis. The shadow by the green light GL emitted from the plurality of small lenses 81 of the second lens array 80 and the shadow SD are linearly formed on the imaging surface FB. The dimension dD of the width of the shadow SD is sufficiently smaller than the dimension dP of the pixel 402 and is equal to or smaller than 1/10 of the dimension dP. In the illumination device 601 of the first embodiment, when the angle θ formed by the center line of the shadow SD with respect to the Z axis is 0° or more and 90° or less, the formula (2) is satisfied.

$${sin}^{- 1} ( \frac{dD}{dsz} ) < θ < {cos}^{- 1} ( \frac{dD}{dsx} ) \qquad ( 2 )$$

In the illumination device 601 of the first embodiment, also by satisfying the formula (2), it is possible to avoid a state in which the shadows by the green light GL formed by the plurality of small lenses 81 of the second lens array 80 are arranged along the Z axis or the X axis and the plurality of shadows overlap each other. According to the illumination device 601 of the first embodiment, it is possible to suppress the illuminance difference of the green light GL on the imaging surface FB and reduce the illuminance unevenness of the green light GL by avoiding a state in which the overlap between the shadows becomes apparent.

In the illumination device 601 of the first embodiment, the ratio of the diameter on the Z axis to the diameter on the Y axis of the small lens 81 of the second lens array 80 is a:b, and the formula (4) is satisfied.

$${tan}^{- 1} ( \frac{a}{b} ) \neq θ \qquad ( 4 )$$

In the illumination device 601 according to the first embodiment, regarding the shadows by the green light GL emitted from the plurality of small lenses 81 of the second lens array 80, it is possible to avoid a state in which the largest number of shadows mutually overlap the shadow SD inclined with respect to the Z axis and the X axis on the imaging surface FB and the illuminance unevenness of the green light GL on the imaging surface FB becomes the most apparent. According to the illumination device 601 of the first embodiment, it is possible to surely suppress the illuminance difference of the green light GL on the imaging surface FB to more reliably reduce the illuminance unevenness of the green light GL.

In the illumination device 601 of the first embodiment, the natural number m, which is the number of small lenses 81 contained in the second lens array 80, is an odd number. The angle θ is set such that the number of shadows by the green light GL overlapping each other is smaller than m.

According to the illumination device 601 of the first embodiment, the illumination and illuminance of the green light GL on the imaging surface FB are easily homogenized. Therefore, the illumination device 601 can be used as a homogenous illumination system.

The projector (optical apparatus) 11 according to the first embodiment includes the illumination device 601 according to the first embodiment. Specifically, in the projector 11 according to the first embodiment, other portions of the illumination device 601 than the light modulation device 400G are disposed at the −Y side of the light modulation device 400G, that is, at the incident side of the light modulation device 400G in the optical paths of the green light GL and the infrared light IL. The light modulation device 400G converts the green light GL into the green image light, emits the green image light toward the +Y side, and transmits the infrared light IL toward the +Y side.

In the projector 11 according to the first embodiment, the illumination device 601 forms an illumination optical system of the green light GL. According to the projector 11 of the first embodiment, in the illumination device 601, the patterned light including the pattern F with the infrared light IL in the infrared wavelength band is generated, and when the green light GL in the visible wavelength band in which the patterned light is not ideally generated is incident on the optical element 531, it is possible to suppress the illuminance unevenness in the green light GL caused by the scattered light, the diffracted light, or the like according to the pattern F to reduce the visibility of the pattern in the green light GL.

### Second Embodiment

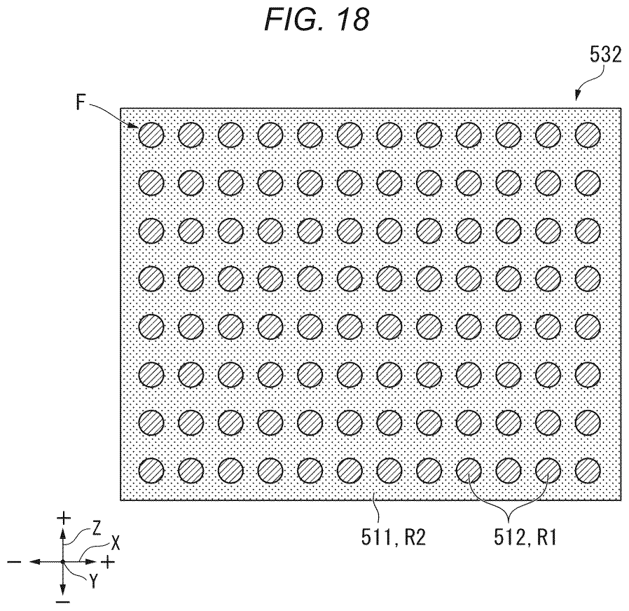

Then, a second embodiment of the present disclosure will be described with reference to FIGS. 18 to 22. Note that in each of the second and subsequent embodiments, the same reference numerals as those of the corresponding components of the preceding embodiment are given to the components common to the preceding embodiment, and the description overlapping that in the preceding embodiment will be omitted. In each of the second and subsequent embodiments, configurations, actions, advantages, and modified examples different from those of the first embodiment will be described.

### Projector

Although not shown, a projector according to the second embodiment has substantially the same configuration as that of the projector 11 according to the first embodiment, and includes an optical element 532 disposed at the same position as the optical element 531 instead of the optical element 531.

### Optical Element

FIG. 18 is a front view of the optical element 531, and is a diagram viewed from the direction in which the green light GL and the infrared light IL are incident, that is, from the −Y side along the Y axis. As illustrated in FIG. 18, the optical element 531 includes the transmission portion 511 and the blocking portions 512. The transmission portion 511 transmits both the green light GL and the infrared light IL to emit the green light GL and the infrared light IL toward the +Y side along the Y axis. The blocking portions 512 transmit the green light GL to emit the green light GL toward the +Y side along the Y axis, and reflect or absorb the infrared light IL to thereby block the infrared light IL.

The blocking portions 512 are arranged in a predetermined pattern F. The predetermined pattern F is, for example, a plurality of dot patterns. When viewed along the Y axis, each pattern that constitutes the blocking portion 512 has, for example, a circular shape. The blocking portions 512 are configured with, for example, circular regions two-dimensionally arranged at appropriate intervals along the X axis and the Z axis on a plate surface at the −Y side parallel to a surface including the X axis and the Z axis of a plate-shaped member constituting the optical element 532.

As described later, in an illumination device according to the second embodiment, it is assumed that a shadow SD by the green light GL formed on a modulation surface of the light modulation device 400 by the small lenses 81 constituting the second lens array 80 is formed in a curved line. Therefore, the peripheral edges of the predetermined pattern F in the optical element 532 of the second embodiment including the dot patterns are formed of curved lines.

In the second embodiment, similarly to the first embodiment, the maximum dimension in a plane including the X axis and the Z axis of the blocking portions 512 each having a circular shape as a plurality of elements constituting the pattern F of the optical element 531 is equal to or larger than a distance ds between two shadows SD adjacent to each other on the modulation surface of the light modulation device 400G, that is, an imaging surface FB, that is, equal to or larger than a distance dsz or equal to or larger than a distance dsx as described later. Further, in the second embodiment, a minimum distance, which is an interval in a plane including the X axis and the Z axis between the plurality of blocking portions 512 each having the circular shape and constituting the pattern F, is equal to or less than the distance ds, that is, equal to or less than the distance dsz or equal to or less than the distance dsx.

The predetermined pattern F is not limited to the plurality of circular patterns configured with the curved peripheral edges in a plane including the X axis and the Z axis as illustrated in FIG. 18, and may be a pattern of one or more marks or characters configured with curved peripheral edges that can be imaged by the imaging device 710. The predetermined pattern F may be, for example, a single circular or elliptical pattern, or may be one or more crescent-shaped patterns formed by curved peripheral edges in a plane including the X axis and the Z axis.

### Illumination Device

Although not illustrated, the illumination device of the second embodiment has substantially the same configuration as the illumination device 601 of the first embodiment, and includes the optical element 532 instead of the optical element 531. In the second embodiment, in the illumination device, the shadow SD is formed in a curved line when viewed along the Y axis.

### <Pattern 1: Condition Where Shades Overlap in Curves Approximate to Vertical and Horizontal Lines>

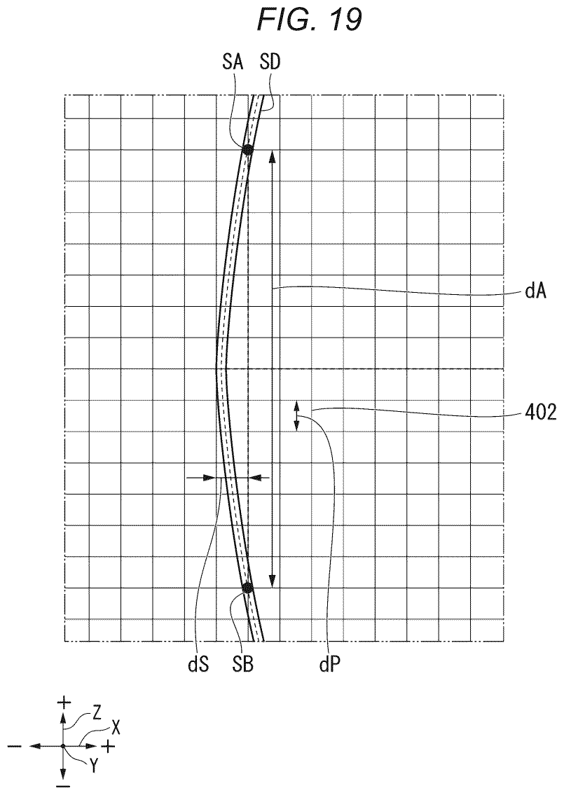

FIG. 19 is a schematic diagram of the shadow SD formed by one of the plurality of small lenses 81 of the second lens array 80 when the dimension of the width of the shadow SD by the green light GL on the modulation surface of the light modulation device 400G is smaller than the dimension of the pixel 402. Similarly to the first embodiment, it is assumed that the dimension dD is zero for simplicity. The darkness of a single curved shadow SD is affected by the integration values of the illuminance and the brightness of the green light GP incident on the pixel 402 of the light modulation device 400G from the plurality of small lenses 81 of the second lens array 80.

As shown in FIG. 19, in consideration of a region in which the curved shadow SD can be approximated by a straight line along the vertical direction with respect to the plurality of pixels 402 of the light modulation device 400G, when the arrow height of the shadow SD, that is, the dimension dI of the height of the arc is substantially equal to the dimension dP of the pixel 402, the length in the vertical direction of the shadow SD corresponds to the length of a chord corresponding to the dimension dI of the curved shadow SD, that is, the dimension dA of a line segment connecting the point SA and the point SB. The dimension dA is expressed by a formula (5).

$$dA = 2 \times \sqrt{\{ {dR}^{2} - {( dR - dP )}^{2} \}} \qquad ( 5 )$$

The characters dR in the formula are the dimension of the curvature radius of the curved shadow SD and is omitted in FIG. 19. A portion connecting the point SA and the point SB in the shadow SD is approximated to a line segment along the Z axis. When the number of small lenses 81 on the Z axis of the second lens array 80 is m, the number of shadows formed by the small lenses 81 and overlapping each other at the imaging surface FB is m at the maximum. When an interval between the shadows adjacent to each other on the imaging surface FB, that is, a distance between the shadows is ds, and a dimension on the Z axis of a region that can be approximated to a line segment out of the curved shadow SD is dA, a condition for the number of shadows overlapping each other on the imaging surface FB to be less than m is expressed by a formula (6) since m×ds≥dA is satisfied.

$$( m - 1 ) \times ds \geq 2 \times \sqrt{\{ {dR}^{2} - {( dR - dP )}^{2} \}} \qquad ( 6 )$$

In the formula (6), for example, the distance ds corresponds to the distance dsz when the overlap of the shadow SD in the vertical direction is considered, and corresponds to the distance dsx when the overlap of the shadow SD in the horizontal direction is considered. In the illumination device of the second embodiment, when the shadow SD has a curved shape when viewed along the Y axis, when at least the formula (6) is satisfied, the illuminance unevenness of the green light GL on the imaging surface FB is reduced compared to the illumination device and the illumination optical system in which m shadows may overlap each other as in the related art.

The total number of small lenses 81 of the second lens array 80 is set to a natural number no smaller than 5 in many cases. Based on this, for example, the condition that the number of shadows overlapping each other on the imaging surface FB is three or less is expressed by a formula (7) since m=4 is set.

$$3 \times ds \geq 2 \times \sqrt{\{ {dR}^{2} - {( dR - dP )}^{2} \}} \qquad ( 7 )$$

As another example, the condition that the number of shadows overlapping each other on the imaging surface FB is two or less is expressed by a formula (8) since m=3 is set.

$$2 \times ds \geq 2 \times \sqrt{\{ {dR}^{2} - {( dR - dP )}^{2} \}} \qquad ( 8 )$$

The most preferable condition that the shadows do not overlap each other on the imaging surface FB is expressed by a formula (9).

$$ds \geq 2 \times \sqrt{{dR}^{2} - {( dR - dP )}^{2}} \qquad ( 9 )$$

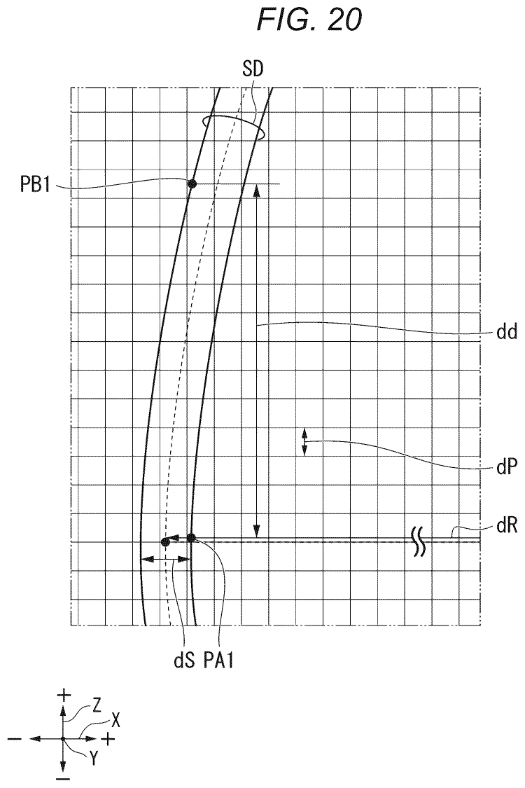

Then, in a second configuration of the pattern 1 of the illumination device of the second embodiment, it is assumed that the dimension dD of the width of the shadow SD by the green light GL is larger than the dimension dP of the pixel 402 of the light modulation device 400G. FIG. 20 is a schematic diagram of the shadow SD when the dimension of the width of the shadow SD by the green light GL on the modulation surface of the light modulation device 400G is equal to or larger than the dimension of the pixel 402. FIG. 20 illustrates a single shadow SD formed by the green light beam GP1 emitted from one small lens 81 of the second lens array 80.

When the width of the shadow SD, that is, the dimension on the X axis is dS, and the curvature radius of the center line of the curved shadow SD is dR, as illustrated in FIG. 20, a position where the edge at the inner peripheral side of the shadow SD is located is defined as PA1, and a position of the edge at the outer peripheral side of the shadow SD crossing when moving from the position PA1 toward the +Z side along the Z axis is defined as PB1. The distance dd between the position PA1 and the position PB1 is expressed by a formula (10).

$$dd = \sqrt{2 \times ( dR - dS )} \qquad ( 10 )$$

The number of shadows SD overlapping each other can be considered classifying the condition based on the relationship between the distance dd and the distance dsx on the X axis between the center lines of the shadows SD. As an example for making understanding easy, it is assumed that three small lenses 81 are arranged along the vertical direction, that is, the Z axis in the second lens array 80.

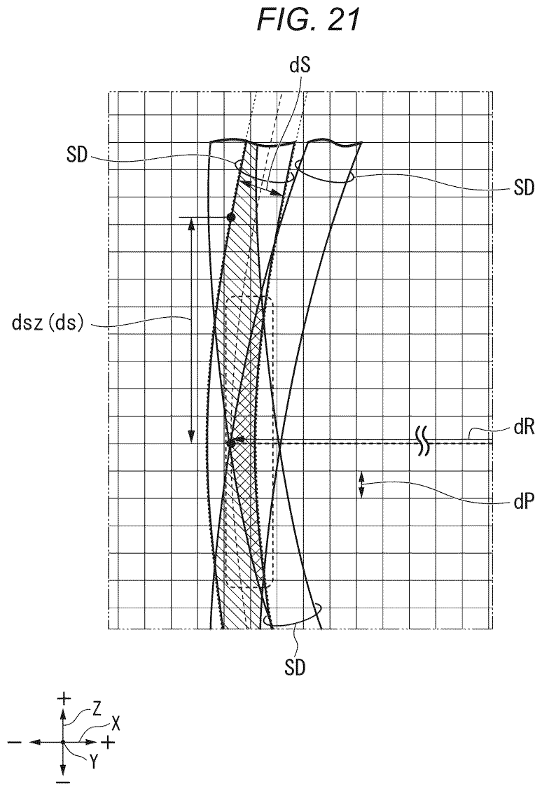

When the distance dd is longer than the distance dsz, that is, when dd>dsz is satisfied, the three shadows SD may overlap each other in the direction along the Z axis. FIG. 21 is a schematic diagram of a state in which the three shadows SD overlap each other when the dimension of the width of the shadow SD by the green light GL on the modulation surface of the light modulation device 400G is equal to or larger than the dimension of the pixel 402 and dd>dsz is satisfied. As illustrated in FIG. 21, in the modulation surface of the light modulation device 400G, a region indicated by hatching with oblique lines where two shadows SD overlap each other and a region indicated by hatching with cross lines where three shadows SD overlap each other are generated. In the area indicated by the hatching with cross lines where the three shadows SD overlap each other, the illuminance of the green light GL is significantly reduced and the illuminance unevenness is likely to become apparent on the modulation surface of the light modulation device 400G compared to the area where the shadow SD is not formed and the area where only one shadow SD is formed and no other shadows SD overlap therewith.

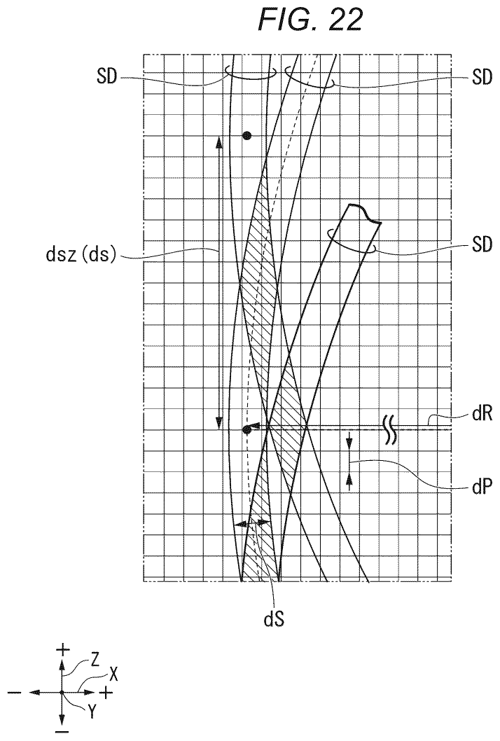

When the distance dd is smaller than the distance dsz, that is, when dd<dsz is satisfied, the two shadows SD may overlap each other. FIG. 22 is a schematic diagram of the state in which the two shadows SD overlap each other when the dimension of the width of the shadow SD by the green light GL on the modulation surface of the light modulation device 400G is equal to or larger than the dimension of the pixel 402 and dd<dsz is satisfied. In the situation illustrated in FIG. 22, the region indicated by the hatching with oblique lines where the two shadows SD overlap each other is generated, but the region where the three shadows SD overlap each other is not generated. Therefore, in the situation illustrated in FIG. 22, the illuminance unevenness is less likely to be visually recognized compared to a situation in which the region where the three shadows SD overlap each other is generated as illustrated in FIG. 21.

In reality, the second lens array 80 includes the m small lenses 81 arranged along the Z axis. Assuming that the distances between the center lines of the shadows SD are equal to each other, and are larger than the dimension dS of the shadows SD, and dd<dsz×(m−1)/2 is satisfied, the m shadows SD at the maximum may overlap each other on the modulation surface of the light modulation device 400G. Therefore, the condition under which the illuminance unevenness of the green light GL on the modulation surface of the light modulation device 400G is reduced compared to the related-art illumination device is expressed by a formula (11).

$$( m - 1 ) \times dsz \geq 2 \times \sqrt{2 \times dR \times dS} \qquad ( 11 )$$

As described in the first embodiment, the total number of small lenses 81 provided to the second lens array 80 is often set to a natural number no smaller than 5, and in that case, it is desirable to reduce the number of shadows SD overlapping each other. In this case, the condition that the number of shadows SD that may overlap each other on the modulation surface, that is, the imaging surface FB of the light modulation device 400G is three or less is expressed by a formula (12), and the condition that the number of shadows SD that may overlap each other on the modulation surface, that is, the imaging surface FB of the light modulation device 400G is two or less is expressed by a formula (13).

$$3 \times dsz \geq 2 \times \sqrt{2 \times dR \times dS} \qquad ( 12 )$$

$$2 \times dsz \geq 2 \times \sqrt{2 \times dR \times dS} \qquad ( 13 )$$

Note that also in the second embodiment, when the contour of the shadow SD is blurred by the illumination optical system of the illumination device and it is difficult to clearly define the dimension dD, it is sufficient for the dimension dD to be defined in consideration of the light intensity distributions of the green light GL and the visible light with which the optical element 532 is irradiated. For example, the light intensity distribution of the shadow SD by the green light GL formed by each of the small lenses 81 of the second lens array 80 may be approximated to an appropriate function, and the dimension of the half width, the 1/e width, the 1/e² width, or the 1/10 width with respect to the peak or the bottom of the function may be adopted as the dimension dD.

### SUMMARY

The illumination device according to the second embodiment described above includes the light emitting element (first light source) 102 of the light source device 100, the collimating element 105, the light emitting elements (second light source) 152 of the light source device 150, the optical element 532, and the second lens array (lens array) 80, and further includes the first lens array 70. The optical element 532 is disposed on the optical path of the green light GL emitted from the collimating element 105 and the infrared light IL emitted from the light emitting elements 152.

In the illumination device of the second embodiment, the optical element 532 is zoned into the first region R1 and the second region R2 when viewed along the optical axis AX20 of the green light GL incident thereon. In the first region R1, the green light GL is transmitted, and the infrared light IL is blocked by, for example, being reflected or absorbed. In the second region R2, both the green light GL and the infrared light IL are transmitted. In the illumination device of the second embodiment, the distance df in the optical path of the green light GL between the second lens array 80 and the imaging surface FB, the distance dm in the optical path of the green light GL between the optical element 532 and the imaging surface FB, the natural numbers m, n, and the ratio between the diameter on the Z axis and the diameter on the Y axis of the small lens 81 are set such that the green light GL that is emitted from the plurality of small lenses 81 of the second lens array 80, and is incident on the optical element 532, and passes through the peripheral edge of the first region R1 is projected onto the imaging surface FB to thereby cause a smaller number of shadows than n by the green light GL to overlap each other on the imaging surface FB.

Note that also in the second embodiment, the description is presented with a focus on when the m small lenses 81 are arranged along the vertical direction, that is, the Z axis when viewed along the direction in which the green light GL is incident on the second lens array 80, that is, the X axis. In reality, when the n×m small lenses 81 are two-dimensionally arranged in a plane including the Y axis and the Z axis, the vertical direction of the second lens array 80 in the description of the illumination device of the second embodiment may be converted into the horizontal direction, the Z axis may be converted into the Y axis, and the dimensions and distances corresponding to each direction and each axis may appropriately be converted. In the same case, the vertical direction of the modulation surface, that is, the imaging surface FB of the light modulation device 400G in the description of the illumination device of the second embodiment may be converted into the horizontal direction, the Z axis may be converted into the X axis, and the dimensions and the distances corresponding to each direction and each axis may appropriately be converted. As a result, in the second lens array 80, when the n×m small lenses 81 are two-dimensionally arranged in a plane including the Y axis and the Z axis, and n is a natural number no smaller than m, as described in the second embodiment, the condition in which a smaller number of shadows SD than m may overlap each other in the vertical direction is applied as a condition in which a smaller number of shadows than n by the green light GL overlap each other on the imaging surface FB. In the illumination device of the second embodiment, the distances df, dm, the natural numbers m, n, the ratio between the diameter on the Z axis and the diameter on the Y axis of the small lens 81, and the number of first regions R1 and blocking portions 512, the maximum dimension on the plane including the X axis and the Z axis, and the distance between the first region R1 and the blocking portion 512 in the optical element 531 are appropriately set based on the design policy and the condition applied as the condition in which a smaller number of shadows than n by the green light GL overlap each other on the imaging surface FB.

In the illumination device of the second embodiment, the green light GL emitted from the light emitting element 102 passes through the plurality of small lenses 81 of the second lens array 80, then passes through the first region R1 and the second region R2 of the optical element 532, and then forms an image on the imaging surface FB with substantially the same configuration as the configuration of the illumination device 601 of the first embodiment. The infrared light IL emitted from the light emitting elements 152 is blocked by the first region R1 of the optical element 532 while being transmitted through the second region R2, and is blocked in accordance with the first region R1 on the imaging surface FB to form the pattern F″ according to the pattern F with the infrared light IL. According to the illumination device of the second embodiment, the spectral characteristics are imparted to the first region R1 due to the difference in behavior between the green light GL and the infrared light IL in the first region R1 of the optical element 532. According to the illumination device of the second embodiment, the imaging surface FB is illuminated with the green light GL that does not include the predetermined pattern F and the infrared light IL that includes the pattern F″ according to the predetermined pattern F. The pattern F″ in the second embodiment is formed by deriving from the predetermined pattern F, and is a plurality of circular patterns overlapping regions occupied by the multilayer film 575 when viewed along the Y axis, and patterns in which the entire regions occupied by the multilayer film 575 are slightly shifted respectively toward the −X side, the +X side, the −Z side, and the +Z side in accordance with the scattering direction and the diffraction direction of the green light beams GL1, GL2.

In the illumination device of the second embodiment, the green light beam GL1 is incident on the first region R1 of the optical element 532 from the −Y side along the Y axis, and the green light beam GL2 is incident on the second region R2 from the −Y side along the Y axis, but a small part of the green light beams GL1, GL2 is scattered or diffracted at the boundary between the first region R1 and the second region R2, that is, the peripheral edge of the multilayer film 575. Since the green light beams GL1, GL2 scattered or diffracted at the peripheral edge of the multilayer film 575 weaken each other due to the phase difference between the green light beams GL1, GL2, the peripheral edge of the multilayer film 575 may form a shadow by the green light GL that illuminates the imaging surface FB from each of the small lenses 81 of the second lens array 80. In the illumination device of the second embodiment, the distances df, dm, the natural numbers m, n, and the ratio between the diameter on the Z axis and the diameter on the X axis of the small lens 81 are appropriately set in accordance with the relative positions and the pattern F of the boundaries between the first regions R1 and the second region R2 in the plane including the X axis and the Z axis, that is, the peripheral edges of the multilayer film 575 so that a smaller number of shadows than n by the green light GL overlap each other on the imaging surface FB. In the related-art illumination device, parameters such as the distances df, dm, the natural numbers m, n, and the ratio between the diameter on the Z axis and the diameter on the X axis of the small lens 81 are set without considering the conditions described above, and there is a possibility that illuminance unevenness due to a portion where n or more shadows by the green light GL overlap each other on the imaging surface FB becomes apparent. According to the illumination device of the second embodiment, since a smaller number of shadows than n by the green light GL overlap each other on the imaging surface FB, it is possible to suppress the illuminance difference of the green light GL on the imaging surface FB to suppress the actualization of the illuminance unevenness of the green light GL and the color difference ΔE*_{ab} of the visible light including the green light GL, and the visibility of the pattern F″ according to the pattern F.

The illumination device according to the second embodiment further includes the light modulation device (image processing device) 400 having the modulation surface (processing surface). The modulation surface of the light modulation device 400 includes a plurality of pixels 402 and is disposed at the imaging surface FB in the optical path of the green light GL. When the dimensions on the Z axis and the X axis of the pixel 402 are defined as dP and the distance between the center lines of two shadows (two shadows) SD adjacent to each other at the imaging surface FB is defined as ds, dP<ds is satisfied.

Also in the illumination device according to the second embodiment, the shadow SD formed in a curved line on the imaging surface FB including the X axis and the Z axis includes a plurality of shadows formed by the green light GL emitted from the plurality of small lenses 81 of the second lens array 80. According to the illumination device of the second embodiment, even when the distance ds between the curved shadows SD adjacent to each other on the imaging surface FB is larger than the dimension dP of the pixel 402 of the light modulation device 400G, it is possible to prevent the shadows SD from overlapping each other to suppress the illuminance difference of the green light GL on the imaging surface FB, and to reduce the illuminance unevenness of the green light GL.

In the illumination device according to the second embodiment, the plurality of pixels 402 of the light modulation device 400G are arranged along at least one of the Z axis and the X axis, and are arranged, for example, two-dimensionally along the Z axis and the X axis. The shadow by the green light GL emitted from the plurality of small lenses 81 of the second lens array 80 and the shadow SD are formed in curved lines on the imaging surface FB. In the illumination device of the second embodiment, when the curvature radius of the center line of the shadow SD is dR, the formula (6) holds.

$$( m - 1 ) \times ds \geq 2 \times \sqrt{\{ {dR}^{2} - {( dR - dP )}^{2} \}} \qquad ( 6 )$$

According to the illumination device of the second embodiment, even when the shadow SD is formed in a curved line and the dimension dS of the width of the shadow SD is smaller than the dimension dP of the pixel 402, it is possible to avoid a state in which the overlap between the shadows becomes apparent to suppress the illuminance difference of the green light GL on the imaging surface FB and to reduce the illuminance unevenness of the green light GL.

In the illumination device according to the second embodiment, as described above, the shadows SD by the green light GL emitted from the plurality of small lenses 81 of the second lens array 80 are formed in curved lines on the imaging surface FB, and when the curvature radius of the center line of the shadow SD is dR, the formula (11) holds.

$$( m - 1 ) \times dsz \geq 2 \times \sqrt{2 \times dR \times dS} \qquad ( 11 )$$

According to the illumination device of the second embodiment, even when the shadow SD is formed in a curved line and the dimension dS of the width of the shadow SD is larger than the dimension dP of the pixel 402, it is possible to avoid a state in which the overlap between the shadows becomes apparent to suppress the illuminance difference of the green light GL on the imaging surface FB and to reduce the illuminance unevenness of the green light GL.

In the illumination device of the second embodiment, the total number n×m of small lenses 81 of the second lens array 80 is an odd number no smaller than 5, and the formula (13) holds.

$$2 \times dsz \geq 2 \times \sqrt{2 \times dR \times dS} \qquad ( 13 )$$

According to the illumination device of the second embodiment, the shadow SD is formed in a curved line as described above, the illuminance unevenness of the green light GL on the imaging surface FB is reduced, and further, the number of small lenses 81 of the second lens array 80 is optimized to an odd number no smaller than 5, and the green light GL on the imaging surface FB, that is, the modulation surface of the light modulation device 400G can be homogenized.

Although not shown, the projector 11 according to the second embodiment includes the illumination device according to the second embodiment. In the projector according to the second embodiment, other portions of the illumination device of the second embodiment than the light modulation device 400G are disposed at the −Y side of the light modulation device 400G, that is, at the incident side of the light modulation device 400G in the optical paths of the green light GL and the infrared light IL.

In the projector according to the second embodiment, the illumination device according to the second embodiment forms an illumination optical system of the green light GL. According to the projector of the second embodiment, in the illumination device of the second embodiment, the patterned light including the pattern F with the infrared light IL is generated, and when the green light GL in which the patterned light is not ideally generated is incident on the optical element 532, it is possible to suppress the illuminance unevenness in the green light GL caused by the scattered light, the diffracted light, or the like according to the pattern F to reduce the visibility of the pattern in the green light GL.

### Third Embodiment

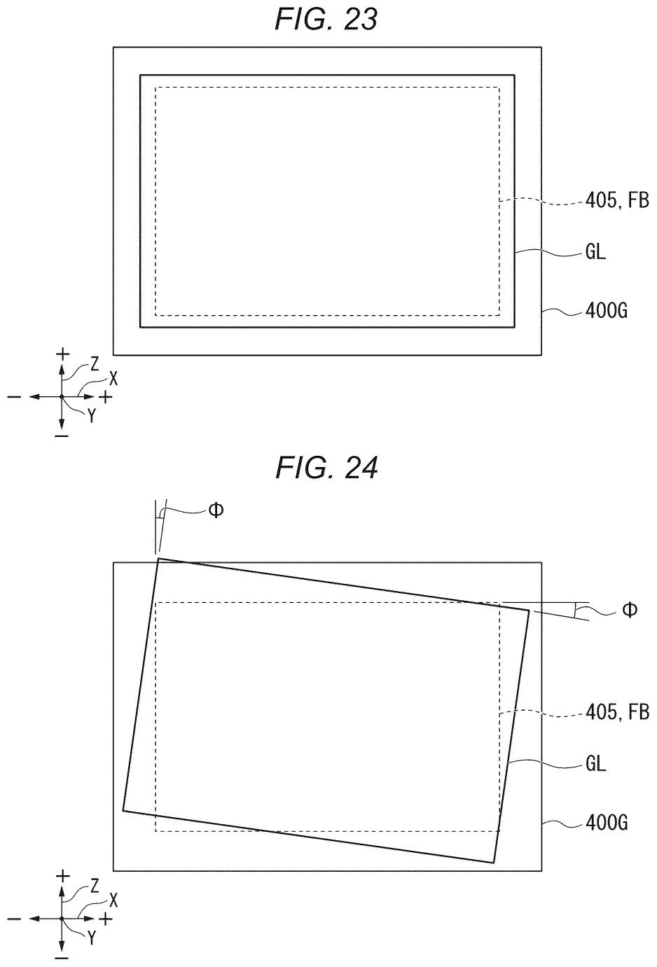

Then, a third embodiment of the present disclosure will be described with reference to FIGS. 23 to 25. The third embodiment corresponds to a modified example of the first embodiment. FIG. 23 is a schematic diagram when a modulation surface 405 including the plurality of pixels 402 of the light modulation device 400G in the projector 11 and the illumination device 601 according to the first embodiment and a region actually irradiated with the green light GL are viewed from the −Y side along the Y axis. The modulation surface 405 of the light modulation device 400G corresponds to a processing surface described in the present specification and a processing surface set forth in the appended claims. In FIG. 23, the plurality of pixels 402 is omitted.

### Illumination Device

In the projector 11 and the illumination device 601 according to the first embodiment, the outer shape of the light modulation device 400G and the modulation surface 405 have a rectangular shape having long sides parallel to the X axis and short sides parallel to the Z axis when viewed along the Y axis. The dimension on the Z axis of the modulation surface 405 is larger than the dimension on the X axis of the modulation surface 405. In this case, although not illustrated, in the second lens array 80, the number n of small lenses 81 arranged on the Y axis is larger than the number m of small lenses 81 arranged on the Z axis in accordance with the shape of the modulation surface 405.

An illumination region of the green light GL illuminated and superimposed on the modulation surface 405 of the light modulation device 400G by the illumination device 601 has a rectangular shape having long sides parallel to the X axis and short sides parallel to the Z axis similarly to the modulation surface 405. The dimension on the Z axis of the illumination region of the green light GL with respect to the light modulation device 400G is larger than the dimension on the X axis of the illumination region. In order to make it possible to reliably illuminate all the pixels 402 of the modulation surface 405 with the green light GL, the illumination region of the green light GL by the illumination device 601 is larger than the modulation surface 405 of the light modulation device 400G on the X axis and the Z axis, and includes a margin region on the outer peripheral side of the modulation surface 405.

Although not illustrated, the projector according to the third embodiment is provided with substantially the same configuration as that of the projector 11 according to the first embodiment. The illumination device of the third embodiment is provided with substantially the same configuration as the illumination device 601 of the first embodiment. However, in the illumination device of the third embodiment, the small lenses 81 of the second lens array 80 are arranged along a direction inclined with respect to both the Y axis and the Z axis in a plane including the Y axis and the Z axis.

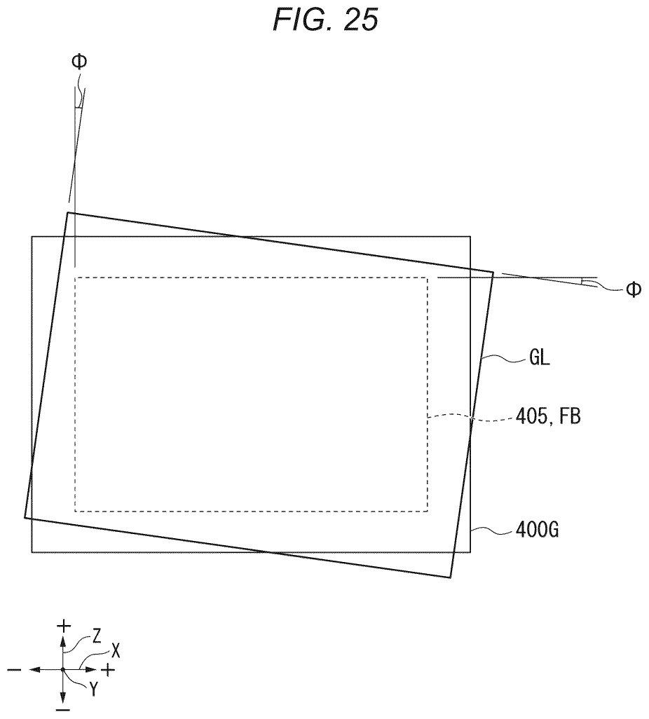

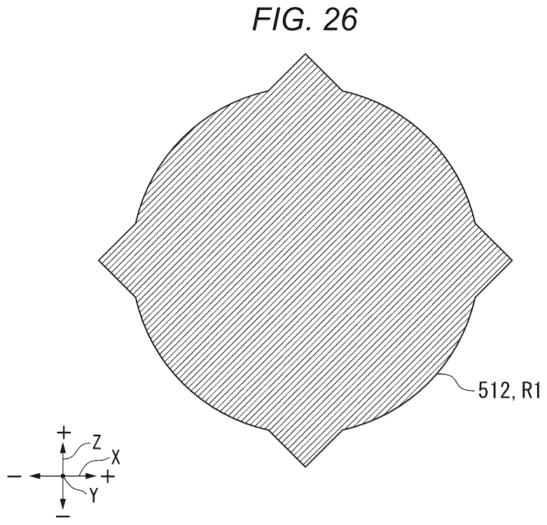

FIGS. 24 and 25 are schematic diagrams when a modulation surface 405 including the plurality of pixels 402 of the light modulation device 400G in the illumination device according to the third embodiment and a region actually irradiated with the green light GL are viewed from the −Y side along the Y axis. In the third embodiment, for example, the small lenses 81 of the second lens array 80 are arranged in a plane including the Y axis and the Z axis along a direction in which a point moves toward the −Z side as the point moves toward the +Y side, and along a direction in which a point moves toward the +Y side as the point moves toward the +Z side.

As shown in FIG. 24, the short sides of the illumination region of the green light GL which illuminates the light modulation device 400G from the −Y side each form an angle φ with respect to the short side of the modulation surface 405 and the Z axis. The long sides of the illumination region of the green light GL each form the angle φ with respect to the long side of the modulation surface 405 and the X axis. The illumination region of the green light GL illustrated in FIG. 24 has an equivalent shape and dimensions to the illumination region of the green light GL illustrated in FIG. 23. In this case, the green light GL does not illuminate an end region at the −X side and the −Z side and an end region at the +X side and the +Z side in the modulation surface 405 of the light modulation device 400G.

In order to surely illuminate all the pixels 402 of the modulation surface 405 with the green light GL when the small lenses 81 of the second lens array 80 are arranged along the direction inclined with respect to both the Y axis and the Z axis, and the long sides and the short sides of the region irradiated with the green light GL are inclined at an angle φ of 0° or more and 90° or less with respect to the long sides and the short sides of the modulation surface 405, respectively, the illumination region of the green light GL needs to be further enlarged in accordance with the angle φ than the region including the margin region described above. The long sides and the short sides of the illumination region of the green light GL illustrated in FIG. 25 are larger than the long sides and the short sides of the illumination region of the green light GL illustrated in FIGS. 23 and 24 in accordance with the angle φ.

As illustrated in FIGS. 24 and 25, when the long sides and the short sides of the region irradiated with the green light GL are inclined at the angle φ with respect to the long sides and the short sides of the modulation surface 405, the distances df, dm, the natural numbers m, n, the ratio between the diameter on the Z axis and the diameter on the Y axis of the small lens 81, and so on of the illumination device of the third embodiment are appropriately set based on the same design policy and conditions as those of the first embodiment with the angle φ set to the angle θ described in the first embodiment.

### SUMMARY

The illumination device according to the third embodiment described hereinabove has substantially the same configuration as the illumination device 601 according to the first embodiment, and the distance df in the optical path of the green light GL between the second lens array 80 and the imaging surface FB, the distance dm in the optical path of the green light GL between the optical element 531 and the imaging surface FB, the natural numbers m, n, the ratio between the diameter on the Z axis and the diameter on the Y axis of the small lens 81, the number of first regions R1 and blocking portions 512 in the optical element 531, the maximum dimension in the plane including the X axis and the Z axis, and the distance between the first region R1 and the blocking portions 512 are appropriately set, and thus the operations and the advantages described in the first embodiment are achieved.

In the illumination device according to the third embodiment, the plurality of pixels 402 of the light modulation device 400G is arranged along an axis crossing the Z axis (first axis) and the X axis (second axis) in a plane including the Z axis and the X axis. In the above description related to the illumination device according to the third embodiment, there is presented the configuration in which the plurality of pixels 402 are arranged along the X axis and the Z axis, and the small lenses 81 of the second lens array 80 are arranged along the direction (axis) crossing the Z axis and the Y axis in a plane including the Z axis and the Y axis. This configuration is treated in substantially the same manner as the configuration in which the plurality of pixels 402 is arranged along the axis crossing the Z axis and the X axis as described above and the plurality of small lenses 81 is arranged along the Z axis and the Y axis in the way that the axis on which the plurality of pixels 402 is arranged and the axis on which the plurality of small lenses 81 is arranged cross each other at a predetermined angle φ when viewed along the optical axis of the green light GL, and applies to the design policy and the condition described above.

In the illumination device of the third embodiment, since the angle φ corresponds to the angle θ described in the first embodiment, and the shadow SD by the green light GL formed by the plurality of small lenses 81 of the second lens array 80 rotates in a plane including the Z axis and the X axis around the rotation center, it is easy to avoid a state in which the plurality of shadows overlaps each other. According to the illumination device of the third embodiment, it is possible to avoid the state in which overlapping of shadows becomes apparent to reduce illuminance unevenness of the green light GL on the imaging surface FB.

Since the projector (optical apparatus) according to the third embodiment includes the illumination device according to the third embodiment and has substantially the same configuration as that of the projector 11 according to the first embodiment, the projector (optical apparatus) provides the same functions and advantages as those of the projector 11 according to the first embodiment.

### Fourth Embodiment

Subsequently, a fourth embodiment of the present disclosure will be described. Although not illustrated, the fourth embodiment corresponds to a modified example of any one of the first to third embodiments. In the fourth embodiment, the maximum dimension in a plane including the X axis and the Z axis of the blocking portion 512 having a crisscross shape or a circular shape which is a plurality of elements constituting the pattern F of the optical element provided to the illumination device and the projector is smaller than the distance ds between the two shadows SD adjacent to each other on the modulation surface of the light modulation device 400G, that is, the imaging surface FB, that is, the distance dsz or the distance dsx. Further, in the fourth embodiment, the minimum distance, which is an interval on the plane including the X axis and the Z axis between the plurality of blocking portions 512 each having a crisscross or circular shape and constituting the pattern F, is longer than the distance ds, that is, the distance dsz or the distance dsx.

In the illumination device and the projector according to the fourth embodiment, the plurality of shadows caused by the plurality of blocking portions 512 of the optical element is formed apart from each other on the modulation surface, that is, the imaging surface FB of the light modulation device 400G regardless of the shape viewed along the Y axis of the blocking portion 512. For this reason, in the illumination device and the projector according to the fourth embodiment, the state in which the overlap between the shadows becomes apparent does not occur, and the illuminance unevenness of the green light GL on the imaging surface FB is reduced to the maximum.

The illumination device according to the fourth embodiment described above has substantially the same configuration as the illumination device 601 according to the first embodiment, and the distance df in the optical path of the green light GL between the second lens array 80 and the imaging surface FB, the distance dm in the optical path of the green light GL between the optical element 531 and the imaging surface FB, the natural numbers m, n, the ratio between the diameter on the Z axis and the diameter on the Y axis of the small lens 81, the number of first regions R1 and blocking portions 512 in the optical element 531, the maximum dimension in the plane including the X axis and the Z axis, and the distance between the first region R1 and the blocking portions 512 are appropriately set, and thus the operations and the advantages described in the first embodiment are achieved.

In the illumination device of the fourth embodiment, a plurality of first regions R1, that is, blocking portions 512 is provided to the optical element. The maximum dimension of the first region R1 and the blocking portion 512 in a plane including the Z axis and the Y axis of the optical element is smaller than the distance ds between the center lines of the shadows SD by the green light GL on the modulation surface and the imaging surface FB of the light modulation device 400G formed by the small lenses 81 of the second lens array 80. The shortest distance between the first regions R1 adjacent to each other in the plane including the Z axis and the Y axis of the optical element and the shortest distance between the blocking portions 512 adjacent to each other in the plane including the Z axis and the Y axis of the optical element are longer than the distance ds.

According to the illumination device of the fourth embodiment, the shadows by the green light GL on the modulation surface and the imaging surface FB of the light modulation device 400G do not overlap each other, and the illuminance unevenness of the green light GL caused by the shadows on the modulation surface and the imaging surface FB of the light modulation device 400G can be reduced to the maximum.

Some preferable embodiments of the present disclosure have been described hereinabove in detail. However, the present disclosure is not limited to such specific embodiments, and various modifications and changes can be made thereto within the scope of the key points of the present disclosure set forth in the appended claims.

In the illumination devices and the projectors according to the embodiments described above, the shapes of the first region R1 and the blocking portion 512 of the optical element when viewed along the Y axis, that is, the optical axis of the green light GL include, for example, a star shape such as a five-corner star or an eight-corner star, a wedge shape, and the like in addition to the crisscross shape as a shape including only straight lines, and include, for example, a complicated shape in which a part of a circle having a small diameter protrudes from a circular peripheral edge, a flower shape, and the like as a shape including only curved lines.

The shapes of the first region R1 and the blocking portion 512 of the optical element when viewed along the Y axis, that is, the optical axis of the green light GL is not limited to the shape including only straight lines or the shape including only curved lines as described above, and may be a shape including a straight line and a curved line. FIG. 26 is a schematic diagram of the first region R1 and the blocking portion 512 in a modified example of the optical element. As illustrated in FIG. 26, the shapes of the first region R1 and the blocking portion 512 of the optical element when viewed along the Y axis, that is, the optical axis of the green light GL may be a shape in which four rectangular corners protrude at equal intervals in the circumferential direction from the peripheral edge of the circular shape. When the first region R1 and the blocking portion 512 of the optical element have a shape including a straight line and a curved line, it is preferable that the design policy and the condition when the first region R1, and the peripheral edge and the shadow of and the blocking portion 512 are linear as described in the above embodiment, and the design policy and the condition when the first region R1, and the peripheral edge and the shadow of the blocking portion 512 are curved as described in the above embodiment are both considered, and the design policies and the conditions in both cases are comprehensively satisfied.

In the projectors according to the embodiments described above, the arrangement of the optical element is not limited to when the optical element is disposed between the field lens 300G and the light modulation device 400G on the optical paths of the green light GL and the infrared light IL emitted from the dichroic mirror 220. As a modified example of the projectors according to the embodiments described above, for example, the reflecting mirror 250 may be replaced with a dichroic mirror, and the optical element may be disposed between the field lens 300R and the light modulation device 400R. In this case, the light source device 150 is disposed at the +X side of that new dichroic mirror, and the red light corresponds to the first light.

The optical apparatus including the illumination device according to any one of the embodiments described above is not limited to the projector, and includes, for example, a head mounted display (Head Mounted Display), a head-up display (Head-U p Display), an exposure device, an illumination device using visible light and invisible light other than the apparatus described above, and the like. The illumination device using visible light and invisible light irradiates a part of a region to be illuminated with, for example, ultraviolet light or infrared light as the invisible light, and irradiates the entire region to be illuminated with the visible light. Such an optical apparatus may be a food illumination device that sterilizes food with ultraviolet rays, or a projector that displays a mark or characters indicating prohibition of imaging to a photographer when imaging with a camera or the like is attempted.

### Summary of Present Disclosure

The present disclosure will be summarized below as appendices.

(Appendix 1) An illumination device including: a first light source configured to emit first light having a first wavelength band; a collimating element configured to collimate the first light emitted from the first light source; a second light source configured to emit second light having a second wavelength band different from the first wavelength band toward an optical path of the first light emitted from the collimating element; an optical element disposed on the optical path of the first light emitted from the collimating element and the second light emitted from the second light source; and a lens array disposed on the optical path of the first light between the collimating element and the optical element, in which the lens array includes a plurality of small lenses, an imaging surface of the first light incident on the small lenses is located at an exit side of the first light with respect to the optical element, in the lens array, m small lenses each identical to the small lens are arranged along a first axis contained in a plane crossing an optical axis of the first light incident on the lens array, and n small lenses each identical to the small lens are arranged along a second axis that is contained in the plane and crosses the first axis, m is a natural number no smaller than 2, n is a natural number no smaller than m, the optical element is zoned, when viewed along the optical path of the first light incident on the optical element, into a first region where the first light is transmitted and the second light is blocked, and a second region where the first light and the second light are transmitted, and a distance in the optical path of the first light between the lens array and the imaging surface, a distance in the optical path of the first light between the optical element and the imaging surface, the natural numbers m, n, and a ratio between a diameter on the first axis and a diameter on the second axis of the small lens are set so that a smaller number of shadows than n by the first light overlap each other on the imaging surface by the first light which is emitted from the plurality of small lenses of the lens array, is then incident on the optical element, and then passes through a peripheral edge of the first region being projected onto the imaging surface.

According to the configuration of Appendix 1, since a smaller number of shadows than n by the first light overlap each other at the imaging surface of the illumination device, it is possible to suppress the illuminance difference of the first light on the imaging surface to suppress the illuminance unevenness of the first light, actualization of the color difference of the visible light including the first light, and to reduce the visibility of the pattern formed on the optical element or the similar pattern according to this pattern.

(Appendix 2) The illumination device according to Appendix 1, further comprising an image processing device having a processing surface, in which the processing surface includes a plurality of pixels and is disposed at the imaging surface in the optical path of the first light, and dP<ds is satisfied, where dP is a dimension of the pixel on the first axis and the second axis, and ds is a distance between center lines of two shadows each identical to the shadow and adjacent to each other at the imaging surface.

According to the configuration of Appendix 2, even when the distance between the linear shadows adjacent to each other on the imaging surface of the illumination device is larger than the dimension of the pixel of the image processing device, it is possible to avoid the overlap between the shadows to reduce the illuminance unevenness of the first light on the imaging surface.

(Appendix 3) The illumination device according to Appendix 2, in which the plurality of pixels is arranged along at least one of the first axis and the second axis, the shadow is linearly formed at the imaging surface, a dimension of a width of the shadow is 1/10 or less of the dimension of the pixel, and the formula (1) described above holds, where θ is an angle between the center line of the shadow and the first axis and is 0° or more and 90° or less.

According to the configuration of Appendix 3, it is possible to avoid a state in which overlap of the plurality of shadows on the imaging surface of the illumination device becomes apparent to thereby reduce the illuminance unevenness of the first light.

(Appendix 4) The illumination device according to Appendix 2, in which the plurality of pixels is arranged along at least one of the first axis and the second axis, the shadow is linearly formed at the imaging surface, a dimension of a width of the shadow is 1/10 or less of the distance between the center lines of the shadows, and the formula (2) described above holds, where θ is an angle between the center line of the shadow and the first axis and is 0° or more and 90° or less.

According to the configuration of Appendix 4, it is possible to avoid a state in which overlap of the plurality of shadows on the imaging surface of the illumination device becomes apparent to thereby reduce the illuminance unevenness of the first light.

(Appendix 5) The illumination device according to Appendix 4, in which a ratio between a diameter on the first axis and a diameter on the second axis of the small lens is a:b, and the formula (4) described above holds.

According to the configuration of Appendix 5, it is possible to avoid the state in which the illuminance unevenness of the first light on the imaging surface of the illumination device is most apparent to further suppress the illuminance difference of the first light on the imaging surface, and to reliably reduce the illuminance unevenness of the first light.

(Appendix 6) The illumination device according to Appendix 5, in which m is an odd number, and the angle is set such that the number of shadows overlapping each other is less than m.

According to the configuration of Appendix 6, the illumination and illuminance of the first light on the imaging surface of the illumination device can be homogenized.

(Appendix 7) The illumination device according to Appendix 2, in which the plurality of pixels is arranged along at least one of the first axis and the second axis, the shadow is formed in a curved line at the imaging surface, and the formula (6) described above holds, where dR is a curvature radius of the center line of the shadow.

According to the configuration of Appendix 7, even when the shadow is formed in a curved line at the imaging surface of the illumination device and the dimension of the width of the shadow is smaller than the dimension of the pixel of the image processing device, it is possible to avoid a state in which the overlap between the shadows becomes apparent to thereby reduce the illuminance unevenness of the first light on the imaging surface.

(Appendix 8) The illumination device according to Appendix 2, in which the plurality of pixels is arranged along at least one of the first axis and the second axis, the shadow is formed in a curved line at the imaging surface, and the formula (11) described above holds, where dR is a curvature radius of the center line of the shadow.

According to the configuration of Appendix 8, even when the shadow is formed in a curved line at the imaging surface of the illumination device and the dimension of the width of the shadow is larger than the dimension of the pixel of the image processing device, it is possible to avoid a state in which the overlap between the shadows becomes apparent to thereby reduce the illuminance unevenness of the first light on the imaging surface.

(Appendix 9) The illumination device according to Appendix 8, in which n×m is an odd number no smaller than 5, and the formula (13) described above holds.

According to the configuration of Appendix 9, the shadow is formed in a curved shape in the configuration of Appendix 8, the illuminance unevenness of the first light on the imaging surface is reduced, and further, the number of small lenses of the lens array is optimized to an odd number no smaller than 5 to thereby make it possible to homogenize the first light on the imaging surface, that is, the processing surface of the image processing device.

(Appendix 10) The illumination device according to any one of Appendices 2 to 9, in which the plurality of pixels is arranged along an axis crossing the first axis and the second axis in a plane including the first axis and the second axis.

According to the configuration of Appendix 10, since the shadow by the first light formed by the plurality of small lenses of the lens array rotates in a plane including the first axis and the second axis around a rotation center, it is possible to avoid a state in which the plurality of shadows overlap each other, that is, a state in which the overlap between the shadows becomes apparent, and to reduce the illuminance unevenness of the first light on the imaging surface.

(Appendix 11) The illumination device according to any one of Appendices 2 to 10, in which a maximum dimension of the first region in a plane including the first axis and the second axis is smaller than the distance between the center lines of the shadows, and a shortest distance between the first regions adjacent to each other in a plane including the first axis and the second axis is longer than the distance between the center lines of the shadows.

According to the configuration of Appendix 11, the shadows by the first light do not overlap each other on the imaging surface, and the illuminance unevenness of the first light caused by the shadows on the imaging surface can be reduced to the maximum.

(Appendix 12) An optical apparatus including the illumination device according to any one of Appendices 1 to 11.

According to the configuration of Appendix 12, in the illumination device according to any one of Appendices 1 to 11, when the patterned light including the pattern F by the second light is generated and the first light that does not ideally generate the patterned light is incident on the optical element, it is possible to suppress the illuminance unevenness in the first light caused by scattered light, diffracted light, or the like according to the pattern F and to reduce the visibility of the pattern in the first light.

What is claimed is:

1. An illumination device comprising:
a first light source configured to emit first light having a first wavelength band;
a collimating element configured to collimate the first light emitted from the first light source;
a second light source configured to emit second light having a second wavelength band different from the first wavelength band toward an optical path of the first light emitted from the collimating element;
an optical element disposed on the optical path of the first light emitted from the collimating element and the second light emitted from the second light source; and
a lens array disposed on the optical path of the first light between the collimating element and the optical element, wherein
the lens array includes a plurality of small lenses,
an imaging surface of the first light incident on the small lenses is located at an exit side of the first light with respect to the optical element,
in the lens array, m small lenses each identical to the small lens are arranged along a first axis contained in a plane crossing an optical axis of the first light incident on the lens array, and n small lenses each identical to the small lens are arranged along a second axis that is contained in the plane and crosses the first axis,
m is a natural number no smaller than 2, n is a natural number no smaller than m,
the optical element is zoned, when viewed along the optical path of the first light incident on the optical element, into a first region where the first light is transmitted and the second light is blocked, and a second region where the first light and the second light are transmitted, and
a distance in the optical path of the first light between the lens array and the imaging surface, a distance in the optical path of the first light between the optical element and the imaging surface, the natural numbers m, n, and a ratio between a diameter on the first axis and a diameter on the second axis of the small lens are set so that a smaller number of shadows than n by the first light overlap each other on the imaging surface by the first light which is emitted from the plurality of small lenses of the lens array, is then incident on the optical element, and then passes through a peripheral edge of the first region being projected onto the imaging surface.

2. The illumination device according to claim 1, further comprising
an image processing device having a processing surface, wherein
the processing surface includes a plurality of pixels and is disposed at the imaging surface in the optical path of the first light, and
dP<ds is satisfied, where dP is a dimension of the pixel on the first axis and the second axis, and ds is a distance between center lines of two shadows each identical to the shadow and adjacent to each other at the imaging surface.

3. The illumination device according to claim 2, wherein
the plurality of pixels is arranged along at least one of the first axis and the second axis,
the shadow is linearly formed at the imaging surface,
a dimension of a width of the shadow is 1/10 or less of the dimension of the pixel, and
a formula (1) holds, where θ is an angle between the center line of the shadow and the first axis and is 0° or more and 90° or less.
$${tan}^{- 1} ( \frac{dP}{dsz - dP} ) < θ < {tan}^{- 1} ( \frac{dsx - dP}{dP} ) \qquad ( 1 )$$
In the formula (1),
dsz is a distance on the first axis between the center lines of the shadows when the angle is 0° or more and 45° or less, and
dsx is a distance on the second axis between the center lines of the shadows when the angle is more than 45° and 90° or less.

4. The illumination device according to claim 2, wherein
the plurality of pixels is arranged along at least one of the first axis and the second axis,
the shadow is linearly formed at the imaging surface,
a dimension of a width of the shadow is 1/10 or less of the distance between the center lines of the shadows, and
a formula (2) holds, where θ is an angle between the center line of the shadow and the first axis and is 0° or more and 90° or less.
$${sin}^{- 1} ( \frac{dD}{dsz} ) < θ < {cos}^{- 1} ( \frac{dD}{dsx} ) \qquad ( 2 )$$
In the formula (2),
dsz is a distance on the first axis between the center lines of the shadows when the angle is 0° or more and 45° or less, and
dsx is a distance on the second axis between the center lines of the shadows when the angle is more than 45° and 90° or less.

5. The illumination device according to claim 3, wherein
a ratio between a diameter on the first axis and a diameter on the second axis of the small lens is a:b, and
a formula (3) holds.
$${tan}^{- 1} ( \frac{a}{b} ) \neq θ \qquad ( 3 )$$

6. The illumination device according to claim 5, wherein
m is an odd number, and
the angle is set such that the number of shadows overlapping each other is less than m.

7. The illumination device according to claim 2, wherein
the plurality of pixels is arranged along at least one of the first axis and the second axis,
the shadow is formed in a curved line at the imaging surface, and
a formula (4) holds, where dR is a curvature radius of the center line of the shadow.
$$( m - 1 ) \times ds \geq 2 \times \sqrt{\{ {dR}^{2} - {( dR - dP )}^{2} \}} \qquad ( 4 )$$
In the formula (4),
ds is the distance on the first axis between the center lines of the shadows.

8. The illumination device according to claim 2, wherein
the plurality of pixels is arranged along at least one of the first axis and the second axis,
the shadow is formed in a curved line at the imaging surface, and
a formula (5) holds, where dR is a curvature radius of the center line of the shadow.
$$( m - 1 ) \times ds \geq 2 \times \sqrt{2 \times dR \times dS} \qquad ( 5 )$$
In the formula (5),
ds is the distance on the first axis between the center lines of the shadows.

9. The illumination device according to claim 8, wherein
n×m is an odd number no smaller than 5, and
a formula (6) holds.
$$2 \times dsz \geq 2 \times \sqrt{2 \times dR \times dS} \qquad ( 6 )$$

10. The illumination device according to claim 2, wherein
the plurality of pixels is arranged along an axis crossing the first axis and the second axis in a plane including the first axis and the second axis.

11. The illumination device according to claim 2, wherein
a maximum dimension of the first region in a plane including the first axis and the second axis is smaller than the distance between the center lines of the shadows, and
a shortest distance between the first regions adjacent to each other in a plane including the first axis and the second axis is longer than the distance between the center lines of the shadows.

12. An optical apparatus comprising
the illumination device according to claim 1.
